(19) United States
(12) Patent Application Publication
(10) Pub. No.: US 2008/0063258 A1
(43) Pub. Date: Mar. 13, 2008

(54) Defect inspection apparatus

(75) Inventor: Toshifumi Kimba, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: EBARA CORPORATION, Tokyo (JP)

(21) Appl. No.: 11/979,143

(22) Filed: Oct. 31, 2007

Related U.S. Application Data
(62) Division of application No. 11/030,320, filed on Jan. 7, 2005.

(30) Foreign Application Priority Data
Jan. 8, 2004 (JP) 3215/2004
Mar. 31, 2004 (JP) 105371/2004

(51) Int. Cl. G06K 9/00

(52) U.S. Cl. 382/149

(57) ABSTRACT

A controller determines, in response to a position coordinate from an X/Y interferometer, which algorism should be used for current inspection, and controls a connection status of a switch to store a reference image corresponding thereto in an image memory. The reference image is one of an image of a sample surface obtained by an image data acquisition unit, an image provided from a cell reference image generation unit, and an image provided from a CAD data reference image generation unit. The controller further controls a connection status of a second switch to provide the reference image associated with the current inspection algorism to an image comparator, where the provided reference image is compared with a currently obtained image. On the basis of a result of the comparison, a defect determination unit determines the presence/absence of a defect. Therefore, an utilization efficiency of a defect inspection apparatus which is capable of performing a plurality of defect inspection algorism, can be improved.

This application is a divisional application of U.S. Ser. No. 11/030,320, filed Jan. 7, 2005, which claims priority of Japanese Patent Application Nos. 3215/2004 and 105371/2004 filed on Jan. 8, 2004 and Mar. 31, 2004, respectively, which are hereby incorporated by reference in their entirety.

### BACKGROUND OF THE INVENTION

The present invention relates to a defect inspection apparatus for inspecting a sample formed with a pattern on the surface thereof to detect defects, and more particularly, to a defect inspection apparatus which irradiates a sample such as a wafer with an electron beam in a semiconductor manufacturing process, captures secondary electrons and the like, which vary depending on the nature of the surface of the sample, to form image data, and evaluates defects on the pattern and the like on the sample surface on the basis of the image data at a high throughput.

In semiconductor manufacturing processes, design rules is about to enter a 100-nm era, and the manufacturing form is shifting from mass manufacturing of one type of product, as represented by DRAM (dynamic random access memory), to flexible (or multiple types and small amount) manufacturing such as SOC (silicon on chip). This shift is accompanied by an increased number of manufacturing steps, at each of which the yield rate must be essentially improved, with importance placed on inspections for defects caused by processes.

With higher integration of semiconductor devices and increasing miniaturization of patterns, inspection apparatuses are required to provide higher resolutions and higher throughput. In order to inspect a wafer for a 100-nm design rule to detect defects, a resolution of 100 nm or less is required. Since the amount of inspections increases due to an increased number of manufacturing steps resulting from higher integration of devices, a higher throughput is required. Also, as devices are formed of a larger number of layers, inspection apparatuses are required to provide a function of detecting defective contacts (electric defects) of viaholes which connect between wire patterns on layers.

In such a defect inspection apparatus, when it is necessary to employ a plurality of defect detection or test algorithms, they are composed with different hardwares and different softwares, as described in Japanese Patent No. 3,187,827.

The defect inspection algorithms contain the followings, for instance:

Cell test algorithm (Array test algorithm);

Die-to-Die test algorithm (Adjacent die comparison test algorithm);

Reference die (Die-to-Any Die) comparison test algorithm; and

CAD data comparison (Cad Data-to-Any Die) test algorithm.

As stated above, one of a plurality of inspection algorithms is selected in accordance with a pattern to be tested and then a defect inspection is executed using the selected algorithm, and the respective inspection algorithms are composed of different hardwares and different softwares in a prior art. Therefore, utilization efficiency of the hardwares and softwares is relatively low.

Further, as described in Japanese Patent No. 3364390, a defect inspection apparatus has been proposed, which is capable of identifying and displaying which wafer has been inspected within a plurality of semiconductor wafers under test, and whether each inspected wafer passes or fails.

However, an apparatus which can display on a display device which samples have been inspected and whether each inspected sample passes or fails, is not capable of displaying in which region on a sample under test is being currently scanned, or at which location a defect is detected in a scanned region of the sample under test.

Therefore, even if a sample currently under test includes a large number of defects in a scanned region and is therefore determined as defective, the inspection apparatus cannot display that the sample is defective until the sample has gone through the test. Thus, the prior art inspection apparatus can determine whether each sample passes or fails only after the sample has undergone a complete defect inspection over the entire area of the sample, and therefore requires the same testing time irrespective of whether each of the samples passes or fails.

Generally, in a semiconductor wafer defect inspection, since it takes several hours to inspect a complete wafer, a challenge exists in reducing an inspection time period to improve the throughput of the defect inspection. However, since such a prior art apparatus as described above requires the same testing time for each wafer, the inspection time period per wafer must be reduced in order to improve the throughput. Nevertheless, a reduction in the inspection time period may degrade inspection accuracy.

Therefore, an earnest desire exists for a defect inspection apparatus which can determine whether or not a wafer fails even in the middle of an inspection.

### SUMMARY OF THE INVENTION

The present invention has been made in view of the problems stated above inherent to the prior art, and a first object thereof is to improve utilization efficiencies of hardwares and softwares in a defect inspection apparatus in which a plurality of inspection algorithms are selectively executed

A second object of the present invention is to provide a defect inspection apparatus which is capable of displaying on a monitor so far a scanned region of a sample such as a semiconductor wafer and defective spots in the scanned region during a defect inspection thereof, thereby permitting an operator to determine whether or not the sample currently under test passes or fail even in the middle of the inspection.

To achieve the first object, in a first aspect, the present invention provides an apparatus for inspecting a defect of a sample having patterns thereon, which comprises:

means for capturing a pattern image of a pattern on a surface of the sample as a target inspection pattern image;

means for capturing and storing a first reference pattern image;

means for capturing and storing a second reference pattern image;

means for obtaining a position coordinate of the target inspection pattern image currently captured from the sample surface, as a current position coordinate;

inspection algorithm storage means storing an inspection algorithm which determines in accordance with the current position coordinate whether the target inspection pattern image should be compared with the first or second reference pattern image;

means for selecting the first or second reference pattern image as a reference pattern image by referring to the inspection algorithm storage means in accordance with the current position coordinate; and

defect determination means for determining whether a defect is present by comparing the target inspection pattern image with the selected reference pattern image.

In the defect inspection apparatus above, it is preferable that the apparatus further comprises: means for capturing and storing a pattern image of a pre-selected die on the sample, as a third reference pattern image; and means for capturing and storing a pattern image of a die obtained from CAD data, as a fourth reference pattern image, wherein the inspection algorithm storage means is adapted to store information indicating whether a reference pattern image is the third or fourth reference pattern image, and the selecting means is adapted to provide the defect determination means with the third or fourth reference pattern image when the inspection algorithm storage means has stored information indicating that the reference pattern image is the third or fourth reference pattern image.

To achieve the first object, the present invention of the first aspect further provides a method of inspecting a defect of a sample having patterns thereon, by comparing a pattern image thereof with a reference pattern image, which comprises the steps of:

storing an inspection algorithm which determines in accordance with a current position coordinate whether the target inspection pattern image should be compared with a first or a second reference pattern image;

capturing and storing the first reference pattern image;

capturing and storing the second reference pattern image;

capturing a pattern image of a pattern on the sample surface as a target inspection pattern image;

obtaining a position coordinate of the target inspection pattern image currently captured from the sample surface, as a current position coordinate;

selecting the first or second reference pattern image as a reference pattern image by referring to the inspection algorithm in accordance with the current position coordinate; and

determining whether a defect is present by comparing the target inspection pattern image with the selected reference pattern image.

In the defect inspection apparatus and method of the present invention of the first aspect, it is preferable that the sample contains a plurality of dies thereon, the first reference pattern image is a cell image of a periodic pattern, and the second reference pattern image is a die reference pattern image of a die. In this event, it is preferable that the die reference pattern image is a pattern image of a die adjacent to a die currently under inspection, a pattern image of a pre-selected die on the sample, or a pattern image of a die obtained from CAD data.

Since the prevent invention of the first aspect is constituted as described above, a plurality of inspection algorisms can be selectively performed using a hardware/software. In addition, two or more algorisms can be performed even on one wafer. Accordingly, utilization efficiencies of a hardware/software can be improved.

To achieve the second object of the present invention, in a second aspect, the present invention provides an apparatus for inspecting a defect of a sample having a pattern, which comprises:

defect detection means for comparing image data representative of a surface of the sample generated by scanning the sample with reference image data to determine whether a defect is present on the surface, and outputting defect inspection result data indicative of whether a defect is present, in synchronization with scanning; and

control means for receiving the defect test result data from the defect detection means, identifying a scanned region and a non-scanned region based on the received defect test result data, and displaying the regions on a monitor.

In the defect inspection apparatus of the present invention of the second aspect, it is preferable that the control means further comprises means for identifying a defect detected location in the scanned region based on the received defect inspection result data, and displaying the location on the monitor. In this event, it is preferable that at each time when the control means receives defect test result data of one detection unit on the sample, it changes the scanned and non-scanned regions and updates the display of these regions on the monitor, and identifies and additionally displays on the monitor, the defect detected location within the detection unit.

In the defect inspection apparatus according to the present invention of the second aspect, it is preferable that at each time of completion of one scanning on the sample in the Y direction, the control means changes the scanned and non-scanned regions and updates the display of these regions on the monitor, and/or identifies and displays on the monitor, the defect detected location within the scanned region.

Further, in the defect inspection apparatus according to the present invention of the second aspect, it is preferable that the apparatus further comprises means for selectively setting bidirectional scanning in by which the scanning is performed in a predetermined direction and in a direction reverse to the predetermined direction, alternately. Further more, it is preferable that the defect inspection apparatus is adapted to selectively execute a cell inspection algorithm and a die-to-die inspection algorithm, and the control means is adapted to control the defect detecting means to capture and store reference image data, in accordance with whether the defect inspection apparatus is set to the cell inspection algorithm or die-to-die inspection algorithm.

In addition, in the defect inspection apparatus according to the present invention of the second aspect, it is preferable that the defect detection means comprises means for capturing a pattern image of a pattern on the sample surface as a target inspection pattern image, means for capturing and storing a first reference pattern image, means for capturing and storing a second reference pattern image, means for obtaining a position coordinate of the target inspection pattern image currently captured from the sample surface, as a current position coordinate, inspection algorithm storage means storing an inspection algorithm which determines in accordance with the current position coordinate whether the target inspection pattern image should be compared with the first or second reference pattern image, means for selecting the first or second reference pattern image as a reference pattern image by referring to the inspection algorithm storage means in accordance with the current position coordinate, and defect determination means for determining whether a defect is present by comparing the target inspection pattern image with the selected reference pattern image.

Since the defect inspection apparatus according to the present invention of the second aspect is constituted as stated above, an operator of the apparatus can monitor an image of a sample of a display and judge whether the sample under inspection contains a defect(s) even during a continuation of the sample inspection. If a sample is determined to be defect even at a middle of the inspection, the operator can stop the inspection and execute a next sample inspection. Therefore, a throughput of a defect inspection can be improved.

When a bi-directional scanning is executed, the defect inspection throughput can be further accelerated.

In addition, by controlling acquisition and storage of a reference image data in the defect detection means, it is capable of setting that either of a cell inspection algorism and a die-to-die inspection algorism should be performed. Therefore, a plurality of defect inspection algorism can be performed using only one defect detection means.

In the defect inspection apparatus according to the present invention of the first and second aspects, the apparatus preferably comprises an electron gun for irradiating a sample with an electron beam, a deflector for deflecting the electron beam such that the electron beam from the electron gun scans the sample, and a detector for detecting electrons obtained by scanning the electron beam on the sample and having information on the sample surface to output image data representative of the sample surface. Alternatively, the apparatus preferably comprises an electron gun for irradiating a sample with an electron beam, a stage for holding the sample, movable such that the electron beam from the electron gun scans the sample, and a detector for detecting electrons generated by scanning the electron beam on the sample and having information on the sample surface to output image data representative of the sample surface. In the apparatus, it is preferable that the electron gun is adapted to irradiate the sample with one or a plurality of electron beams so that a plurality of pixels are included therein, and the detector is adapted to focus the image of the sample surface on the detector associated with the electrons having information on the sample surface.

### BRIEF DESCRIPTION OF THE DRAWINGS

FIG. 1 is an elevation illustrating main components of a semiconductor wafer inspection system to which the defect inspection apparatus according to the present invention can be applied;

FIG. 2 is a top plan view of the main components of the inspection system illustrated in FIG. 1, taken along a line B-B in FIG. 1;

FIG. 3 is a diagram showing the relationship between a wafer carrier box and a loader in the inspection system illustrated in FIG. 1;

FIG. 4 is a cross-sectional view illustrating a mini-environment apparatus for use with the inspection system illustrated in FIG. 1, taken along a line C-C in FIG. 1;

FIG. 5 is a diagram illustrating a loader housing for use with the inspection system illustrated in FIG. 1, taken along a line D-D in FIG. 2;

FIG. 6 is an explanatory diagram generally illustrating a wafer alignment controller which can be applied to an opto-electro system of the inspection system illustrated in FIG. 1;

FIG. 7 is a diagram for explaining a basic flow of an inspection procedure of a semiconductor devise;

FIG. 8 is a diagram for explaining an inspection die setting on a wafer;

FIG. 9 is a diagram for explaining an inspection area setting procedure of a die;

FIG. 10 is a diagram for explaining an inspection procedure of a semiconductor device according to the present invention;

FIGS. 11(A) and 11(B) are diagrams for explaining an inspection procedure of a semiconductor device according to the present invention;

FIG. 12(A) is a diagram showing how a semiconductor device is scanned when there is one die under inspection thereon;

FIG. 12(B) is a diagram showing a pattern configuration of a die;

FIG. 13 is a diagram for explaining how a cell reference image is generated in an inspection procedure of a semiconductor device according to the present invention;

FIG. 14 is a diagram for explaining an adjacent die comparison inspection method in the semiconductor device inspection procedure;

FIG. 15 is a block diagram showing a defect inspection apparatus for a semiconductor device according to a first aspect of the present invention;

FIG. 16 is a diagram for explaining a inspection method executed in the defect inspection apparatus shown in FIG. 15, in which a die is inspected with a cell inspection method and an adjacent die comparison inspection method;

FIG. 17 is a flowchart illustrating a control procedure executed in the defect inspection apparatus shown in FIG. 15;

FIG. 18 is a block diagram showing a defect inspection apparatus for a semiconductor device according to a second aspect of the present invention;

FIG. 19 is a diagram for explaining a scanning operation in the defect inspection apparatus shown in FIG. 18;

FIG. 20(A) is a semantic diagram of a wafer before a defect inspection operation in the defect inspection apparatus shown in FIG. 18;

FIG. 20(B) is a semantic diagram of a wafer during a defect inspection operation in the defect inspection apparatus shown in FIG. 18;

FIG. 20(C) is a semantic diagram of a wafer after completion of a defect inspection operation in the defect inspection apparatus shown in FIG. 18;

FIG. 21 is a block diagram of a defect detection unit applicable to the defect inspection apparatus shown in FIG. 18;

FIG. 22 is a diagram for explaining a focus mapping in the semiconductor device inspection procedure;

FIG. 23 is a diagram for explaining a focus mapping in the semiconductor device inspection procedure;

FIG. 24 is a diagram for explaining a focus mapping in the semiconductor device inspection procedure;

FIG. 25 is a diagram for explaining a focus mapping in the semiconductor device inspection procedure; and

FIG. 26 is a block diagram illustrating an embodiment of a semiconductor manufacturing line system in which the defect inspection apparatus as shown in FIG. 15 or 18 can be incorporated.

### DETAILED DESCRIPTION OF THE INVENTION

Before describing preferred embodiments of a defect inspection apparatus according to the present invention, description will be made of the general configuration of a semiconductor wafer inspection system which can incorporate and utilize the defect inspection apparatus according to the present invention.

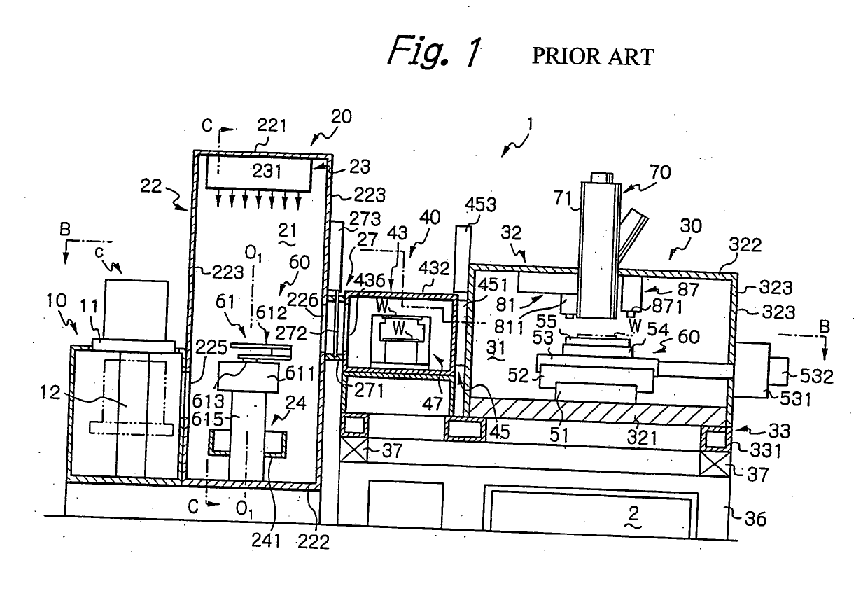

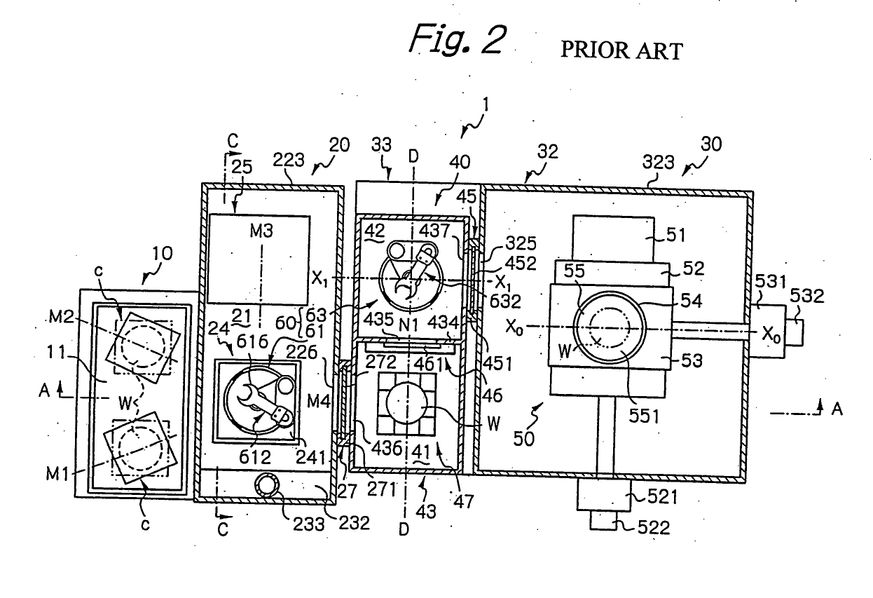

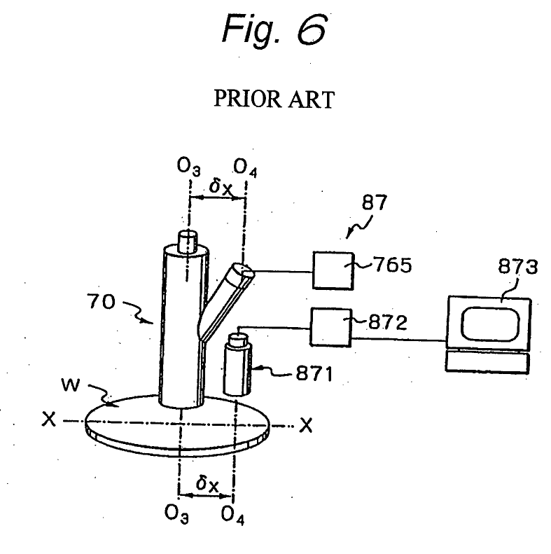

FIG. 1 and 2 are an elevation and a plan view illustrating main components of the inspection system 1, respectively. The inspection system 1 comprises a cassette holder 10 for holding a cassette which contains a plurality of wafers; a mini-environment device 20; a main housing 30; a loader housing 40 disposed between the mini-environment device 20 and the main housing 30 for defining two loading chambers; a stage device 50 disposed within the main housing 30 for carrying a wafer W for movements; a loader 60 for loading a wafer from the cassette holder 10 onto the stage device 50 disposed within the main housing 30; and an opto-electro system 70 mounted in the main housing 30. These components are arranged in a positional relationship as illustrated in FIGS. 1 and 2. The inspection system 1 also comprises a pre-charge unit 81 disposed in the main housing 30 in vacuum; a potential applying mechanism for applying a potential to a wafer; an electron beam calibration mechanism; and an optical microscope 871 which forms part of an alignment control unit 87 (shown in FIG. 6) for aligning a wafer on the stage device 50. The inspection system 1 further comprises a control device 2 for controlling the operation of these components.

In the following, detailed description will be made of the configuration of the respective main components (sub-systems) of the inspection system 1.

Cassette Holder 10

The cassette holder 10 is configured to hold a plurality (two in this embodiment) of cassettes c (for example, closed cassettes such as SMIF, FOUP made by Assist Co.), each of which contains a plurality (for example, 25) of wafers arranged one above another in parallel. When a cassette is transferred and automatically loaded into the cassette holder 10 by a robot or the like, the cassette holder 10 having a suitable structure can be selected for installation. Alternatively, when a cassette is manually loaded into the cassette holder 10, the cassette holder 10 having an open cassette structure, suitable for the manual loading, can be selected for installation. In this embodiment, the cassette holder 10 is a type which allows the cassettes c to be automatically loaded, and comprises, for example, an up/down table 11, and an elevating mechanism 12 for moving up and down the up/down table 11. The cassette c can be automatically loaded onto the up/down table in a state indicated by a chain line in FIG. 2, and after the loading, is automatically rotated to a state indicated by a solid line in FIG. 2 to be oriented to the axis of rotation of a first transfer unit within the mini-environment device 20. The up/down table 11 in turn is moved down into a state indicated by a chain line in FIG. 1.

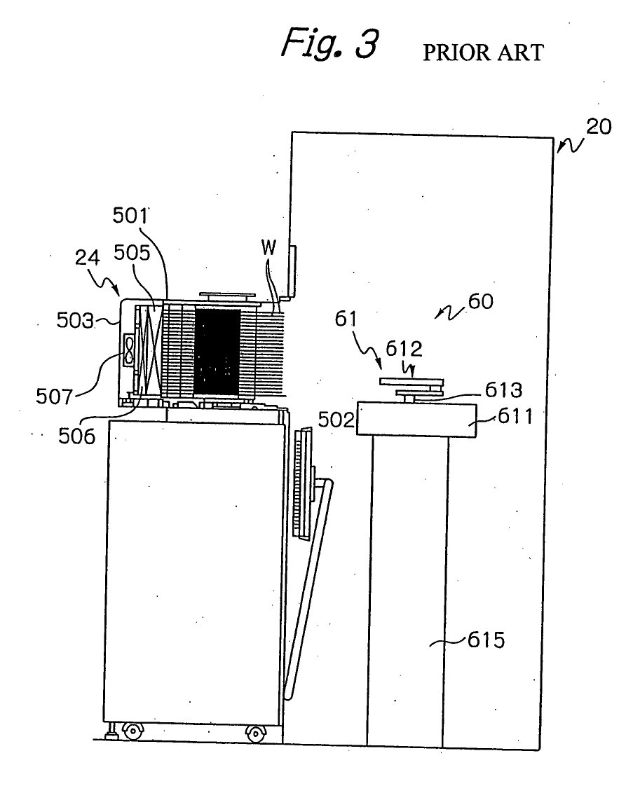

In another embodiment, as illustrated in FIG. 3, a plurality of 300 mm wafers W are placed in groove-shaped pockets (not shown) fixed inside a box body 501, transferred, and stored. A substrate carrier box 24 is coupled to the prism-shaped box body 501 and to an automatic gating device associated with a substrate transfer access door 502, and comprises the substrate transfer access door 502 for mechanically opening and closing an opening on a side surface of the box body 501; a lid 503 positioned opposite to the opening for covering the opening for mounting and removing filters and a fan motor; and a groove-shaped pocket 507 for holding wafers W. In this embodiment, wafers are transferred into and out of the box body 501 by a robot-type transfer unit 61 of the loader 60.

Wafers may be stored in the cassette c after the process for processing the wafers during the semiconductor manufacturing processes or during the process. Specifically, wafers which have undergone deposition, CMP, ion implantation and the like, wafers formed with wiring patterns on the surface thereof, wafers which have not been formed with wiring patterns may be stored in the cassette c for inspecting. Wafers stored in the cassette c are arranged one above another with a spacing therebetween and in parallel with one another, such that a first transfer unit, to be described later, can be moved up and down for holding a wafer at an arbitrary location within the cassette c with an arm thereof.

Mini-Environment Device 20

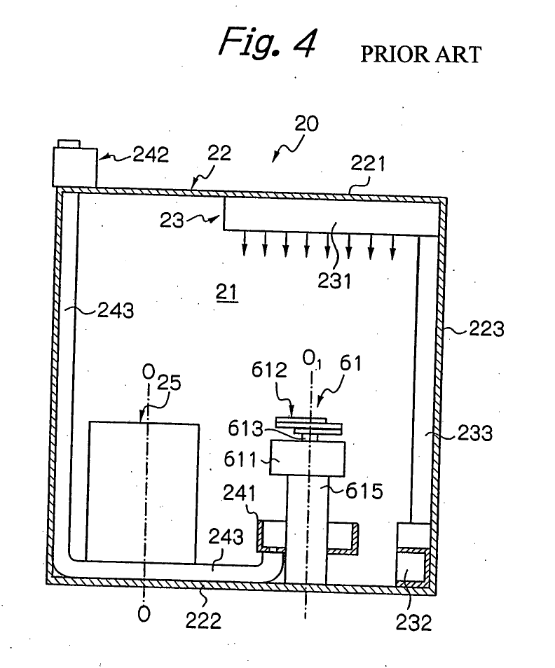

FIG. 4 is an elevation of the mini-environment device 20, taken from a direction different from that in FIG. 1. As illustrated in FIG. 4 and the aforementioned FIGS. 1 and 2, the mini-environment device 20 comprises a housing 22 which defines a mini-environment space 21, the atmosphere of which is controlled; a gas circulator 23 for circulating a gas such as cleaning air within the mini-environment space 21 for controlling the atmosphere; a discharger 240 for recovering part of air supplied into the mini-environment space 21 for emission; and a pre-aligner 25 disposed within the mini-environment space 21 for roughly aligning a wafer which is a sample.

The housing 22 has a top wall 221, a bottom wall 222, and a peripheral wall 223 which surrounds the four sides of the housing 22, and is structured to block the mini-environment space 21 from the outside. For controlling the atmosphere within the mini-environment space 21, the gas circulator 23 comprises a gas supply unit 231 mounted on the top wall 221 to face downward for cleaning a gas (air in this embodiment) and supplying the cleaned air directly therebelow in laminar flow through one or more air blow ports (not shown); a recovery duct 232 mounted on the bottom wall 222 for recovering air which has flown down to the bottom from the gas supply unit 231; and a conduit 233 for connecting the recovery duct 232 to the air supply unit 231 for returning recovered air to the gas supply unit 231, as illustrated in FIG. 4.

The cleaned air, which goes down in laminar flow, is supplied such that it mainly flows through a carrying surface of a first transfer unit, to be described later, disposed within the mini-environment space 21, thereby preventing dust, possibly produced by the transfer unit, from sticking to wafers. A portion of the peripheral wall 223 of the housing 22 adjacent to the cassette holder 10 is formed with an access port 225.

The discharger 240 comprises a suction duct 241 disposed below a transfer unit, to be described later, at a position lower than the wafer carrying surface of the transfer unit; a blower 242 disposed outside the housing 22; and a conduit 243 for connecting the suction duct 241 to the blower 242. This discharger 240 aspires a gas flowing down around the transfer unit and including dust possibly produced by the transfer unit through the suction duct 241 for discharging the gas out of the housing 22 through the conduits 243, 244 and blower 242.

The pre-aligner 25 disposed within the mini-environment space 21 optically or mechanically detects an orientation flat (which refers to a flat portion formed near the outer periphery of a circular wafer) formed on a wafer, or one or more V-shaped notches formed on the outer periphery of a wafer, and preliminarily determines the position of the wafer in a rotating direction about the axial line O₁-O₁ of the wafer with an accuracy of approximately ±1 degree based on the detected orientation flat or V-shaped notches. The pre-aligner 25 forms part of a mechanism for determining the coordinates of the wafer, and is responsible for alignment of wafers.

Main Housing 30

As illustrated in FIGS. 1 and 2, the main housing 30, which defines a working chamber 31, comprises a housing body 32 which is supported by a housing supporting device 33 carried on a vibration blocking device, i.e., a vibration isolator 37 disposed on a base frame 36. The housing supporting device 22 comprises a frame structure 221 assembled into a rectangular shape. The housing body 32, which is securely placed on the frame structure 331, comprises a bottom wall 321 carried on the frame structure 331; a top wall 322; and a peripheral wall 323 connected to the bottom wall 321 and top wall 322 to surround the four sides of the housing body 32 to isolate the working chamber 31 from the outside. In this embodiment, the housing body 32 and housing supporting device 33 are assembled in rigid structure, and the vibration isolator 37 prevents vibrations from a floor on which the base frame 36 is installed from transmitting to the rigid structure. A portion of the peripheral wall 343 of the housing 32 adjacent to the loader housing 40 is formed with an access port 325 for carrying a wafer into and removing a wafer from the loader housing 40.

The working chamber 31 is held in vacuum atmosphere by a general purpose evacuator (not shown). Below the base frame 36, a control device 2 is disposed for controlling the operation of the entire inspection system 1.

In the inspection system 1, a variety of housings including the main housing 30 are evacuated, wherein an evacuation system used for it is composed of vacuum pumps, vacuum valves, vacuum gages, vacuum pipes, and the like for evacuating the opto-electro systems, detector, wafer chamber, load lock chamber and the like in accordance with a predetermined sequence. In the respective components, the vacuum valve is controlled to achieve a required degree of vacuum. Then, the degree of vacuum is monitored at all times, such that in the event of a failure, an urgent control is conducted by an interlock function to disconnect between chambers, or between chambers and emission system with isolation valves or the like, thereby ensuring a required degree of vacuum in each of the components. Vacuum pumps suitable for use with the inspection system 1 may be a turbo molecular pump for main emission, and a Roots-type dry pump for rough pumping. A site under inspection (electron beam irradiated site) may be at pressure in a range of 10⁻³ to 10⁻⁵ Pa, and preferably in a range of 10⁻⁴ to 10⁻⁶ Pa, lower by an order of magnitude, for a practical use.

Loader Housing 40

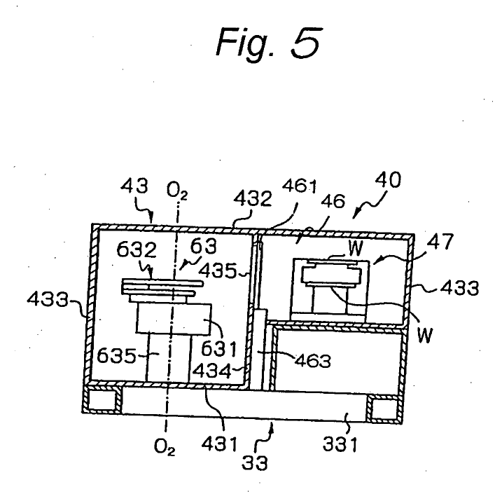

FIG. 5 illustrates an elevation of the loader housing 40 taken from a different direction from that in FIG. 1. As illustrated in FIGS. 5, 1, and 2, the loader housing 40 comprising a housing body 43 which defines a first loading chamber 41 and a second loading chamber 42. The housing body 43 comprises a bottom wall 431, a top wall 432, a peripheral wall 433 which surrounds the four sides of the housing body 43, and a partition wall 434 for partitioning the first loading chamber 41 from the second loading chamber 43, and isolates the two loading chambers from the outside. The partition wall 434 is formed with an opening, i.e., a port 435 for passing or receiving a wafer W between the two loading chambers. Also, a portion of the peripheral wall 433 adjacent to the mini-environment device 20 and main housing 30 is formed with gates 436, 437. The housing body 43 of the loader housing 40 is carried on and supported by the frame structure 331 of the housing supporting device 33. Therefore, no vibrations are transmitted to the loader housing 40 from the floor.

While the access port 436 of the loader housing 40 is in alignment to the access port 226 of the housing 22 of the mini-environment device 20, a shutter 27 is disposed between these access ports 436 and 226 for selectively blocking communications between the mini-environment space 21 and the loading chamber 41. Also, while the access port 437 of the loader housing 40 is in alignment to the access port 325 of the housing body 32 of the main housing 30, a shutter 45 is disposed between these access ports 436 and 325 for selectively blocking communications between the loading chamber 42 and the working chamber 31 in a sealing structure. Further, a shutter 46 is disposed in an opening formed through the partition wall 434 for closing the opening with a door 461 to selectively block communications between the first and second loading chambers in a sealing structure. These shutters 27, 45, 46 can hermetically seal the respective chambers when they are closed.

A wafer rack 47 is arranged within the first loading chamber 41 for horizontally supporting a plurality (two in this embodiment) of wafers W one above another with a space defined therebetween.

The first and second loading chambers 41, 42 are controlled to be in a high vacuum state by a general-purpose evacuator (not shown) including a vacuum pump (the degree of vacuum is in a range of 10⁻⁵ to 10⁻⁶ Pa). In this event, the first loading chamber 41 is held in a low vacuum atmosphere to serve as a low vacuum chamber, while the second loading chamber 42 is held in a high vacuum atmosphere to serve as a high vacuum chamber, thereby making it possible to effectively prevent wafers from contamination. With the employment of such a loading housing structure which comprises two loading chambers, wafers W can be transferred from the loading chamber into the working chamber without delay. Also, the employment of such a loading chamber structure can improve the throughput of a test for defects and the like, and approach the degree of vacuum around the electron source, which must be held in a high vacuum state, to a highest possible vacuum state.

Each of the first and second loading chambers 41, 42 is connected to an evacuation pipe and a vent pipe (not shown) for an inert gas (for example, dry pure nitrogen). With this structure, inert gas vent (an inert gas is injected to prevent an oxygen gas and the like other than the inert gas from sticking to the surface) is achieved in an atmospheric condition within each loading chamber.

It should be noted that in the main housing 30 which uses electron beams, representative lanthanum hexaboride (LaB₆) or the like for use as an electron source, i.e., an electron gun of the opto-electro system 70 should essentially be brought into contact with oxygen or the like with the least possible frequency in order not to reduce the life time thereof. Since the electron source is brought into contact with oxygen with reduced possibilities by conducting the atmospheric control as mentioned above before the wafers W are loaded into the working chamber which contains the opto-electro system 70 of the main housing 30, the life time of the electron source is less likely to be reduced.

Stage Device 50

The stage device 50 comprises a fixed table 51 disposed on the bottom wall 321 of the main housing 30; a Y-table 52 for movements on the fixed table 51 in a Y-direction (in the direction perpendicular to the sheet surface in FIG. 1); an X-table 53 for movements on the Y-table 52 in an X-direction (a left-to-right direction in FIG. 1); a rotary table 54 rotatable on the X-table 53; and a holder 55 disposed on the rotary table 54. Wafers W are releasably held on a wafer carrying surface 551 of the holder 55. The holder 55 may be of a general-purpose structure for releasably chucking a wafer W mechanically or in an electro-statically chucking manner. The stage device 50 operates a plurality of tables 52-54 mentioned above using servo motors, encoders, and a variety of sensors (not shown) for highly accurately aligning a wafer W held by the holder 55 on the carrying surface 551 in the X-, Y-, and Z-directions (an up-to-down direction in FIG. 1), as well as in a rotating direction (θ direction) about an axis normal to the wafer supporting surface with respect to electron beams irradiated from the opto-electro system 70.

For aligning a wafer in the Z-direction, the position of the carrying surface 551 on the holder 55 may be made finely adjustable in the Z-direction, by way of example. In this event, a reference position on the carrying surface 551 may be sensed by a position measuring device using a micro-diameter laser (a later interferometric telemeter using the principle of interferometer) for control by a feedback circuit (not shown), and additionally or alternatively, the position of the notch or orientation flat on a wafer may be measured to sense a planar position and a rotating position of the wafer with respect to an electron beam, and the rotary table 54 is rotated by a stepping motor or the like which can be controlled to operate in small angular increments. The wafers W may be directly placed on the rotary table 54 without providing the holder 55. For maximally preventing dust from occurring within the working chamber 31, the servo motors 521, 531 and encoders 522, 532 for the stage device 50 are disposed outside the main housing 30.

By previously inputting a rotating position and a position on the X-Y coordinate of the wafer W with respect to the electron beam into a signal detection system or an image processing system, later described, signals can be scaled as well.

Loader 60

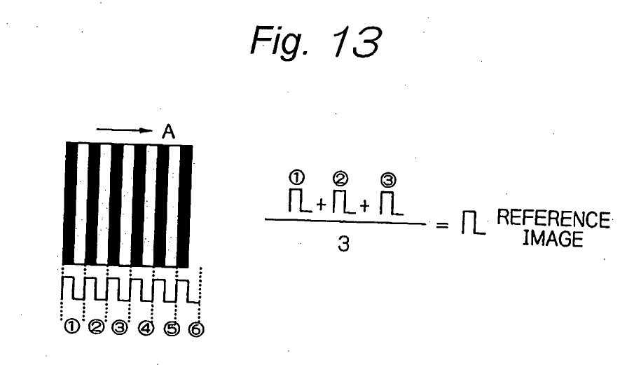

The loader 60 (FIG. 12) comprises a robot-based first transfer unit 61 disposed in the housing 22 of the mini-environment device 20, and a robot-based second transfer unit 63 disposed in the second loading chamber 42.

The first transfer unit 61 has a multi-node arm 612 for rotation about an axis O₁-O₁ relative to a driver 611. While an arbitrary structure may be applied to the multi-node arm, this embodiment employs the multi-node arm 612 which has three parts attached for rotation relative to each other. A part of the arm 612 of the first transfer unit 61, i.e., a first part closest to the driver 611 is attached to a shaft 613 which can be rotated by a driving mechanism (not shown) in a general-purpose structure arranged in the driver 611. The arm 612 is rotatable about the axis O₁-O₁ by the shaft 613, and is telescopical in a radial direction relative to the axis O₁-O₁ as a whole through relative rotations among the parts. At the leading end of the third part furthest away from the shaft 613 of the arm 612, a chuck 616 is attached for chucking a wafer, such as a mechanical chuck in a general-purpose structure, an electrostatic chuck or the like. The driver is vertically movable by an elevating mechanism in a general-purpose structure.

In this first transfer unit 61, the arm 612 extends toward one of two cassettes c held in the cassette holder 10 in a direction M1 or M2 (FIG. 2), and a wafer W stored in the cassette c is carried on the arm, or is chucked by the chuck (not shown) attached at the leading end of the arm for removal. Subsequently, the arm is retracted (to the state illustrated in FIG. 2), and the arm is rotated to a position at which the arm can extend toward the pre-aligner 25 in a direction M3, and is stopped at this position. Then, the arm again extends to the pre-aligner 25 to transfer the wafer held by the arm thereto. After receiving the wafer from the pre-aligner 25 in a manner reverse to the foregoing, the arm is further rotated and stopped at a position at which the arm can extend toward the first loading chamber 41 (in a direction M4), where the wafer is passed to a wafer receiver 47 within the first loading chamber 41. It should be noted that when a wafer is mechanically chucked, the wafer should be chucked in a peripheral zone (in a range approximately 5 mm from the periphery). This is because the wafer is formed with devices (circuit wires) over the entire surface except for the peripheral zone, so that if the wafer were chucked at a portion inside the peripheral zone, some devices would be broken or defects would be produced.

The second transfer unit 63 is basically the same as the first transfer unit 61 in structure, and differs only in that the second transfer unit 63 transfers a wafer W between the wafer lack 47 and the carrying surface of the stage device 50.

The first and second transfer units 61, 63 transfer wafers from the cassette c held in the cassette holder onto the stage device 50 disposed in the working chamber 31 and vice versa while holding the wafer substantially in a horizontal posture. Then, the arms of the transfer units 61, 63 are moved up and down only when a cassette is extracted from the cassette c and loaded into the same, when a wafer is placed on the wafer lack and is extracted from the same, and when a wafer is placed on the stage device 50 and removed from the same. Therefore, the transfer units 61, 63 can smoothly move even a large wafer which may have a diameter of, for example, 30cm.

Now, description will be made in order of the transfer of a wafer from the cassette c supported by the cassette holder 10 to the stage device 50 disposed in the working chamber 31 in the inspection system 1 having the configuration described above.

The cassette holder 10 for use in the inspection system 1 may have an appropriate structure either when cassettes are manually set or when cassettes are automatically set, as mentioned above. In this embodiment, as the cassette c is set on the up/down table 11, the up/down table 11 is moved down by the elevating mechanism 12 to bring the cassette c into alignment to the access port 225. As the cassette c is in alignment to the access port 225, a cover (not shown) disposed on the cassette c is opened, whereas a cylindrical cover is arranged between the cassette c and the access port 225 of the mini-environment device 20 to block the cassette c and mini-environment space 21 from the outside. When the mini-environment device 20 is equipped with a shutter for opening/closing the access port 225, the shutter is operated to open the access port 225.

On the other hand, the arm 612 of the first transfer unit 61 remains oriented in either the direction M1 or M2 (in the direction M1 in this description), and extends to receive one of wafers stored in the cassette c with its leading end as the access port 225 is opened.

Once the arm 612 has received a wafer, the arm 612 is retracted, and the shutter (if any) is operated to close the access port 225. Then, the arm 612 is rotated about the axial line O₁-O₁ so that it can extend in the direction M3. Next, the arm 612 extends to transfer the wafer carried on the leading end thereof or chucked by a chuck onto the pre-aligner 25 which determines a direction in which the wafer is rotated (direction about the center axis perpendicular to the surface of the wafer) within a predetermined range. Upon completion of the positioning, the first transfer unit 61 retracts the arm 612 after the wafer is received from the pre-aligner 25 to the leading end of the arm 612, and takes a posture in which the arm 612 can be extended in the direction M4. Then, the door 272 of the shutter 27 is moved to open the access ports 226, 436, permitting the arm 612 to place the wafer on the upper shelf or lower shelf of the wafer rack 47 within the first loading chamber 41. It should be noted that before the shutter 27 opens the access ports to pass the wafer to the wafer rack 47, the opening 435 formed through the partition 434 is hermetically closed by the door 461 of the shutter 46.

In the wafer transfer process by the first transfer unit 61, clean air flows in a laminar state (as a down flow) from the gas supply unit 231 disposed in the housing body 22 of the mini-environment device 20, for preventing dust from sticking to the upper surface of the wafer during the transfer. Part of air around the transfer unit (in this embodiment, approximately 20% of the air supplied from the gas supply unit 231, which is mainly contaminated) is aspired from the suction duct 241 of the discharger 24 for emission out of the housing body 22. The remaining air is recovered through the recovery duct 232 arranged on the bottom of the housing body 22, and again returned to the gas supply unit 231.

As a wafer is placed on the wafer rack 47 within the first loading chamber 41 of the loader housing 40 by the first transfer unit 61, the shutter 27 is closed to hermetically close the loading chamber 41. Then, the loading chamber 41 is brought into a vacuum atmosphere by expelling the air within the loading chamber 41, filling an inert gas in the loading chamber 41, and then discharging the inert gas. The vacuum atmosphere in the loading chamber 41 may have a low degree of vacuum. As the degree of vacuum has reached a certain level in the loading chamber 41, the shutter 46 is operated to open the access port 434, which has been hermetically closed by the door 461, and the arm 632 of the second transfer unit 63 extends to receive one wafer from the wafer receiver 47 with the chuck 616 at the leading end thereof (placed on the leading end or chucked by a chuck attached to the leading end). As the wafer has been received, the arm 632 is retracted, and the shutter 46 is again operated to close the access port 435 with the door 461. It should be noted that before the shutter 36 opens the access port 435, the arm 632 has previously taken a posture in which it can extend toward the wafer rack 47 in a direction N1. Also, as described above, before the shutter 46 opens the access port 435, the shutter 45 closes the access ports 437, 325 with the door 452 to block communications between the second loading chamber 42 and the working chamber 31, and the second loading chamber 42 is evacuated.

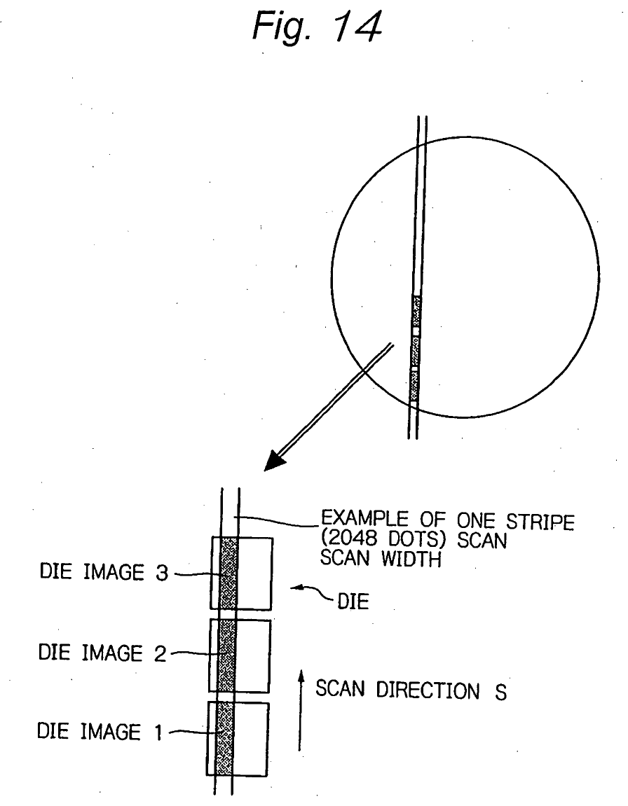

As the shutter 46 closes the access port 435, the second loading chamber 42 is again evacuated to a degree of vacuum higher than that of the first loading chamber 41. In the meantime, the arm 612 of the second transfer unit 61 is rotated to a position from which the arm 612 can extend toward the stage device 50 within the working chamber 31. On the other hand, in the stage device 50 within the working chamber 31, the Y-table 52 is moved upward, as viewed in FIG. 13, to a position at which the center line X₀-X₀ of the X-table 53 substantially matches an X-axis line X₁-X₁ which passes the axis of rotation O₂-O₂ of the second transfer unit 63. Also, the X-table 53 has moved to a position close to the leftmost position, as viewed in FIG. 2, and is waiting at this position. When the degree of vacuum in the second loading chamber 42 is increased to a level substantially identical to that of the working chamber 31, the door 452 of the shutter 45 is moved to open the access ports 437, 325, and the arm 612 extends so that the leading end of the arm, which holds a wafer, approaches the stage device 50 within the working chamber 31. Then, the wafer W is placed on the carrying surface 551 of the stage device 50. Once the wafer W has been placed on the stage device 50, the arm 612 is retracted, and the shutter 45 closes the access ports 437, 325.

The foregoing description has been made of a sequence of operations until a wafer W in the cassette c is transferred to the working chamber 31 and placed on the carrying surface 551 of the stage device 50. For returning a wafer W which has undergone a test from the stage device 50 to the cassette c, operations reverse to the foregoing are performed. Also, since a plurality of wafers are placed on the wafer rack 47, the first transfer unit 62 can transfer a wafer between the cassette c and the wafer rack 47 while the second transfer unit 63 is transferring a wafer between the wafer rack 47 and the stage device 50. Consequently, operations associated with the test can be efficiently conducted.

Opto-Electro System 70

The opto-electro system 70 is a system for producing images of a sample, and any type of electron bean apparatus such as SEM apparatus or image projection apparatus is applicable to the system 70, in which an electron beam(s) is irradiated onto the sample, secondary electrons, reflection electrons, or backward scattered electron are detected, and a sample image is created from the detected electrons. Using such an electron beam apparatus, resolution can be improved. Any electrons can be utilized as electrons to be detected if they carry information of the sample surface thereon. For instance, mirror electrons (in broad sense, so called “reflection electrons”) and transmission electrons which transmit through a sample. The mirror electrons are reflected electrons from the neighborhood of a sample surface (but not from the sample surface), which is supplied with an inverse electric field. In particular, when the mirror electrons are detected, since emitted electrons toward the sample surface are not reached to the sample surface, the charge up of the sample is significantly low.

When utilizing the mirror electrons, the inverse electric field around the neighborhood of the sample surface is created by applying a negative voltage which is lower than an acceleration voltage. The negative voltage is preferably set such that almost all the primary electrons are returned from the locations above the sample surface. It is preferable to set the negative voltage to be 0.5V-1.0V (or more) lower than the acceleration voltage of an electron gun. For instance, when the acceleration voltage is −4 kV, the negative voltage supplied to the sample is set to be in a range of −4.000 kV-−4.050 kV, and preferably in a range of −4.0005-−4.020 kV, and more preferably in a rage of −4.0005 kV-−4.010 kV.

The opto-electro system 70 preferably comprises an electron gun for emitting an electron beam(s) toward a surface of a sample, a deflector for deflecting the electron beam to scan the sample surface, a stage for holding the sample which is movable so that the electron beam is movable on the sample surface, relatively, and a detector for detecting electrons having information of the sample surface and obtained by scanning the sample surface with the emitted electron beam and for providing image data of the sample surface.

It is further preferable that the electron gun is adapted to emit an electron beam(s) on the sample such that the emitted spot on the sample contains a plurality of pixels, and that the detector is adapted to image thereon the sample surface image based on the electrons having the sample surface information.

Pre-Charge Unit 81

The pre-charge unit 81 is disposed in close proximity to the lens column 71 of the opto-electro system 70 within the working chamber 31, as previously shown in FIG. 1. Since the inspection system 1 of the present invention irradiates a wafer with electron beams for scanning to test a device pattern and the like formed on the surface of the wafer, the wafer can be charged on the surface depending on conditions such as the material of the wafer, energy of irradiated electron beams, and the like. Further, the wafer surface may include a region which is more charged and a region which is less charged. In addition, while information on secondary electrons or the like generated by irradiation of electron beams is used for analyzing the wafer surface, possible variations in the amount of charge on the wafer surface may cause the information on the secondary electrons to include variations as well, thereby failing to provide accurate images. To prevent such variations in charge, the pre-charge unit 81 is provided in this embodiment. The pre-charge unit 81 includes a charged particle irradiating unit 811 which irradiates charged particles to a wafer before primary electron beams are emitted for testing, thereby eliminating variations in charge. How the wafer surface is charged can be detected by previously forming an image of the wafer surface using the opto-electro system 70, and evaluating the image. Then, the irradiation of charged particles from the charged particle irradiating unit 811 is controlled based on the detected charging state. The pre-charge unit 81 may irradiate blurred primary electron beams.

Alignment Control Unit 87

The alignment control unit 87 aligns a wafer W to the opto-electro system 70 using the stage device 50. The alignment control unit 87 is configured to control a low magnification alignment (alignment with a lower magnification than the opto-electro system 70) which is a rough alignment of a wafer through a wide field observation using the optical microscope 871 (FIG. 1); a high magnification alignment for a wafer using the opto-electro system 70; focus adjustment; setting of an area under inspection; pattern alignment; and the like. It should be noted that a wafer is tested at a low magnification as mentioned above because for automatically inspecting patterns on a wafer, an alignment mark must be readily detected by electron beams when the wafer is aligned by observing the patterns on the wafer in a narrow field of view using electron beams.

The optical microscope 871 is installed within the main housing 30, but may be movably disposed within the main housing 30. A light source (not shown) for operating the optical microscope 871 is also disposed within the main housing 300. Further, the opto-electro system involved in observations at high magnification shares components (primary optical system 72 and secondary optical system 74) of the opto-electro system 70.

FIG. 6 generally illustrates the configuration of the alignment control unit 87. For observing a site under observation on a wafer W at a low magnification, the site under observation on the wafer W is moved into the field of view of the optical microscope 871 by moving the X-stage or Y-stage of the stage device 50. The wafer W is viewed in a wide field of view using the optical microscope 871, and the site under observation on the wafer W is displayed on a monitor 873 through a CCD 872 to roughly determine where the site under observation is found. In this event, the magnification of the optical microscope 871 may be gradually changed from a low magnification to a high magnification.

Next, the stage device 50 is moved by a distance corresponding to a spacing δx between the optical axis of the opto-electro system 70 and the optical axis of the optical microscope 871, thereby moving the site under observation on the wafer W, which has been previously determined using the optical microscope 871, into the field of view of the opto-electro system 70. In this event, since the distance 8x between the axial line O₃-O₃ of the opto-electro system 70 and the optical axis O₄-O₄ of the optical microscope 871 has been previously known (while both are shifted only in the X-direction in this embodiment, they may be shifted in the Y-direction), the site under observation can be moved to a viewing position of the opto-electro system 70 if the wafer W is moved by the distance δx. After the site under observation has been moved to the viewing position of the opto-electro system 70, the site under observation is imaged at a high magnification by the opto-electro system, and the resulting image is stored or displayed on a monitor 873.

After the site under observation of the wafer is displayed at a high magnification by the opto-electro system as described above, a displacement of the wafer in the rotating direction relative to the center of rotation of the rotary table 54 of the stage device 50, i.e., a shift δθ of the wafer in the rotating direction relative to the optical axis O₃-O₃ of the opto-electro system is detected by a known method, and a displacement of a predetermined pattern is detected in the X-axis and Y-axis directions relative to the opto-electro system 70. Then, the operation of the stage device 50 is controlled to align the wafer based on the detected values, data on a test mark separately attached on the wafer, or data related to the shapes of the patterns on the wafer.

Control Device 2

The control device 2 comprises a plurality of controllers such as main controller, IPE controller and stage controller.

A main controller is provided with a man-machine interface through which the operator performs operations (entering a variety of instructions/commands, recipes and the like, instructing the start of a test, entering all necessary commands for switching between an automatic and a manual test mode, commands involved in the manual test mode, and the like). Otherwise, the main controller is responsible for communications with the host computer in the factory, control of an evacuation system, transfer of wafers, control of positioning, transmission of commands to and reception of information from a stage controller and other controllers, and the like. The main controller also has a stage vibration correcting function for capturing an image signal from an optical microscope and feeding a stage fluctuation signal back to the opto-electro system to correct deteriorated images, and an automatic focus correcting function for detecting a displacement of a wafer observation position in the Z-axis direction (axial direction of the secondary optical system) and feeding the detected displacement to the opto-electro system to automatically correct the focus. The transmission and reception of feedback signals to and from the opto-electro system, as well as the transmission and reception of signals to and from the stage device are performed through the adjustment controller and stage controller, respectively.

The adjustment controller controls the opto-electro system 70, i.e., controls an electron gun, lenses, aligner, Wien filter and the like. In detail, the controller controls automatic voltage setting and the like for the respective lens systems and aligner corresponding to each operation mode (associative control); for example, controlling a power supply such that a constant electron current is irradiated to a target area at all times even if a different scaling factor is selected, and automatically setting voltages to the respective lens systems and aligner corresponding to each scaling factor.

The stage controller enables precise movements on the order of μm in the X-axis direction and Y-axis direction (with a tolerance of approximately ±0.5 μm), and also enables a control in the rotating direction (θ control) within an error accuracy of approximately ±0.3 seconds.

The inspection system 1 further comprises a defect detection apparatus in which data generated by the opto-electro system 70 is processed to acquire image data and detect defects on a wafer based on the acquired image data in accordance with the present invention. A detailed description will be made on a defect detection apparatus for detecting defects on a semiconductor wafer according to the present invention.

Generally, the inspection apparatus using electron beams, i.e., the opto-electro system 70 is expensive and presents a lower throughput than other process apparatuses. For this reason, the inspection apparatus is currently utilized after important processes which are thought to have the most need of the test (for example, etching, deposition, CMP (chemical mechanical polishing) planarization, and the like) or in part of a wiring process which involves finer wires, i.e., one or two steps of the wiring process, in a gate wiring step in the pre-process, and the like. In particular, it is important to find defective shapes and electric defects of wires having a design rule of 100 nm or less, via holes having diameters of 100 nm or less, and the like, and to feed the found defects back to associated processes.

As described above, a wafer to be tested is transferred by the atmosphere transfer system and vacuum transfer system, aligned on the highly precise stage device (X-Y stage) 50, and then fixed by an electrostatic chucking mechanism or the like. Then, in a defect inspection process, an optical microscope is used to confirm the location of each die and detect the height of each location, as required, and such data is stored. The optical microscope is also used to capture an optical microscopic image of desired sites such as defects and to compare electron beam images. Next, conditions are set for the opto-electro system, and an electron beam image is used to modify the information set by the optical microscope to improve accuracy.

Next, information on recipes is entered to the apparatus depending on the type of wafer (after which process, whether the wafer size is 200 mm or 300 mm, and the like). Subsequently, after specifying a inspection place, setting the opto-electro system, setting inspection conditions, and the like, a defect test is normally conducted in real time while images are captured. A comparison of cells to one another, a comparison between dies, and the like are performed by a high speed information processing system which has associated algorithms installed therein, and the results are output to a CRT or the like, and stored in a memory, as required.

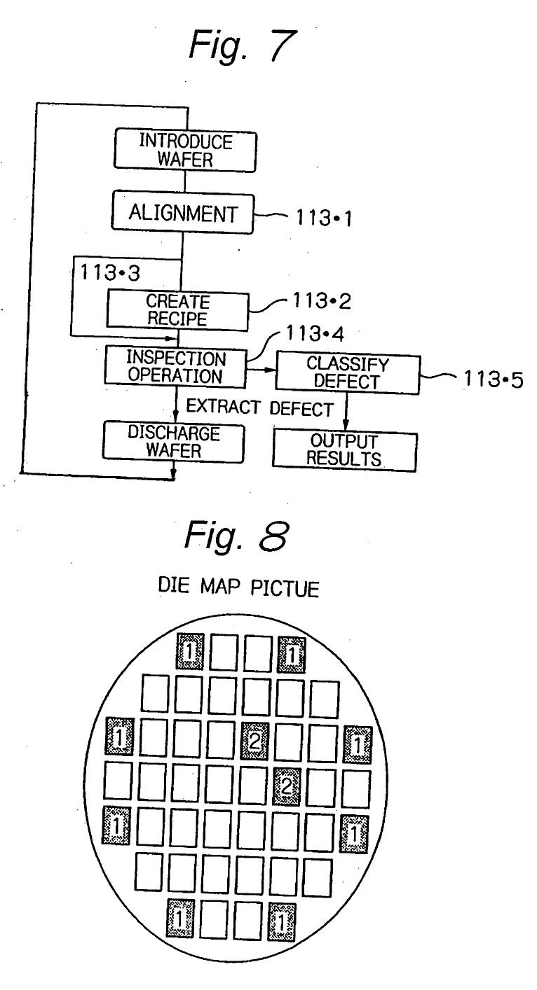

FIG. 7 illustrates a basic flow of the defect test. First, after transfer of wafers including an alignment operation 113-1, the recipes are created for setting conditions related to the test, and the like (113-2). While at least one type of recipe is needed for each wafer under inspection, a plurality of recipes may be created for a single wafer under inspection in order to support a plurality of inspection conditions. Also, when there is a plurality of wafers having the same pattern, the plurality of wafers may be tested in accordance with a single recipe. A path 113-3 in FIG. 7 indicates that when a test is conducted using recipes created in the past, the creation of recipes is not required immediately before the inspection operation.

In FIG. 7, the inspection operation 113-4 involves a test on a wafer in accordance with the conditions described in the recipe and a sequence. A defect is extracted immediately each time it is found during the inspection operation through the following operations which are executed substantially in parallel.
Defects are classified (113-5) to add extracted defect information and defect classification information to a result output file.
An extracted defect image is added to a result output file dedicated to images or to a file.
Defect information such as locations of extracted defects is displayed on an operation screen.

Upon completion of the test on a wafer-by-wafer basis, the following operations are next executed substantially in parallel.
The result output file is closed and saved.
When the result of the test is requested through a communication from the outside, the result of the test is sent.
The wafer is removed.

When the inspection system is set to continuously test wafers, the next wafer under inspection is transferred, followed by a repetition of the sequence of operations described above.

In the creation of recipes in FIG. 7, recipes created therein include a file for setting conditions associated with the test, and the like. The recipes can be saved as well, so that the recipes may be used to set conditions at the time of or before a test. The conditions associated with the test described in the recipes include, for example, the following items:
dies under inspection;
region to be tested within a die;
inspection algorithm;
detecting conditions (required for extracting defects, such as a test sensitivity); and
observation conditions (magnification, lens voltages, stage speed, inspection order, and the like, which are required for observation).

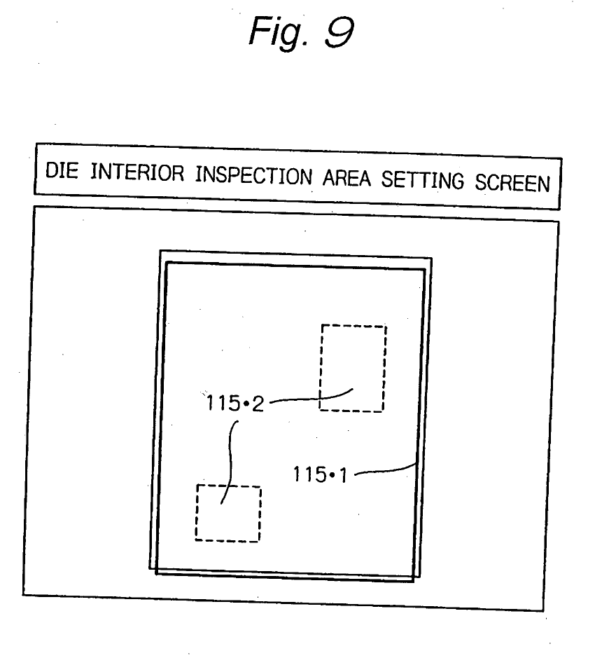

Among the test conditions listed above, the setting of dies under inspection involves an operator specifying dies to be tested on a die map screen displayed on the operation screen, as illustrated in FIG. 8. In the example of FIG. 8, dies 1 near the periphery of the wafer and dies 2 clearly determined as defective in the pre-process are grayed out and removed from dies under inspection, and the remaining dies are subjected to the test. The alignment control unit 2 also has a function of automatically specifying dies under inspection based on the distance from the periphery of the wafer and information on good/fail of dies detected in the pre-process.

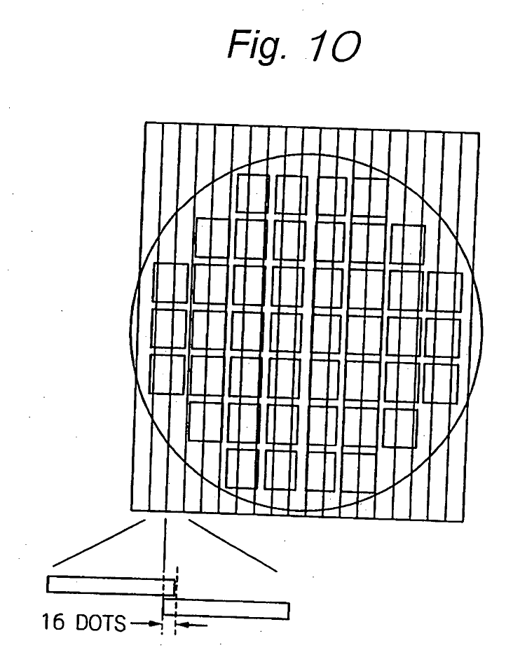

An area under inspection within a die is specified by the operator on a die internal test region setting screen displayed on the operation screen, as illustrated in FIG. 9, using an input device such as a mouse based on an image captured by an optical microscope or an EB microscope. In the example of FIG. 9, an area 115-1 indicated by a solid line, and an area 115-2 indicated by a broken line are set to be areas under inspection.

The area 115-1 includes substantially the entire die which is set to be under inspection. In this event, an adjacent die comparison method is employed for a test algorithm, and detailed detection conditions and observation conditions for this area are separately set. For the area 115-2, an array test is employed for a test algorithm, and detection conditions and detailed observation conditions for this area are separately set. Thus, a plurality of areas under inspection can be set, and an appropriate test algorithm and test sensitivity can be set for each of the areas. Also, when some areas under inspection are overlapped, a predetermined test algorithm having a priority is executed for the same area. In the example in FIG. 9, only the array test is performed for the area 115-2 and the adjacent die test is not performed for it.

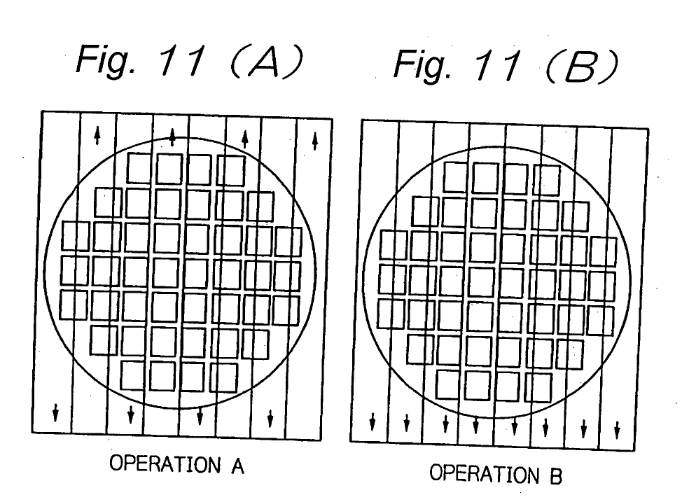

In the inspection operation 113-4 in FIG. 7, a wafer under inspection is sectioned in scanning widths, as illustrated in FIG. 10. The scanning width is substantially determined by the length of a line sensor, but is set such that adjacent line sensors slightly overlap in their respective edge portions. This is intended to ensure a margin for determining the continuity between lines when detected defects are totally processed at a final stage, and for an alignment of images involved in a comparison test. An overlapping amount is approximately 16 dots for a 2,048-dot line sensor.

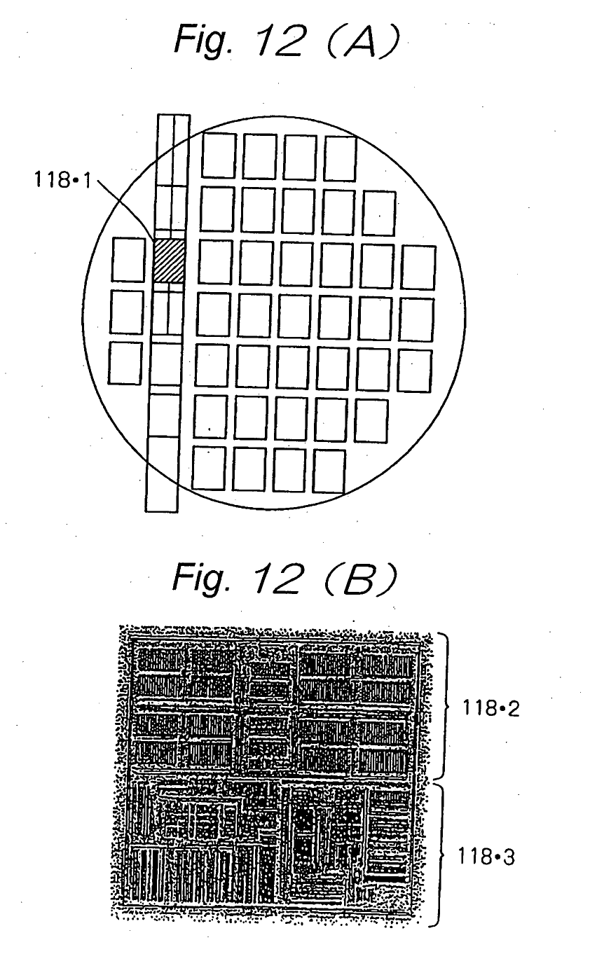

FIGS. 11(A) and 44(B) schematically illustrate scanning directions and sequences. Specifically, a bi-directional operation (Operation A) for reducing a test time, and a uni-directional operation (Operation B) due to mechanical restrictions can be selected by the operator.

The control unit also has a function of automatically processing and detecting to execute an operation which reduces the amount of scanning for the test based on target die information stored in the recipe. FIG. 12(A) shows an example of scanning which is done when there is only one die under inspection, in which case unnecessary scanning is omitted.

A test algorithm set by the recipe can be classified into a cell test (array test) and a die test (random test).

As illustrated in FIG. 12(B), a die is divided into a cell area 118-2 which has a periodic structure mainly used for memories, and a random area 118-3 which does not have the periodic structure. Since the cell area 118-2 having the periodic structure includes a plurality of cells to be compared within the same die, the cells within the same die can be tested using the cell test by comparing them with one another. On the other hand, since the random area 118-3 cannot be compared within the same die, dies must be compared using the die test. The die test method is further classified as follows depending on what is compared:
Adjacent die comparison method (Die-to-Die test);
Reference die comparison method (Die-to-Any Die test); and
CAD data comparison method (Cad Data-to-Any Die test).

A scheme generally called a “golden template scheme” falls under the basic die comparison method and CAD data comparison method. In the reference die comparison method, a reference die is used as a golden template, while in the CAD data comparison method, CAD data is used as a golden template.

The following description will be made on the operation of the respective test algorithms.

Cell Test (Array Test)

The cell test is applied to a test of a periodic structure. A DRAM cell is an example which is suitable for the cell test.

The test involves comparing a reference image with an image under inspection, and extracting differences therebetween as defects. The reference image and image under inspection may be digitized images or multi-valued images for improving the detection accuracy.

While defects may be differences themselves between the reference image and the image under inspection, a secondary determination may be made in order to prevent erroneous detections based on difference information such as the amount of detected difference, a total area of pixels which present differences, and the like.

In the cell test, the comparison of the reference image with the image under inspection is made in units of structural periods. Specifically, they may be compared in units of structural periods while reading the images collectively captured by a CCD or the like, or when the reference image comprises n units of structural periods, the n units of structural period can be compared at the same time.

FIG. 13 illustrates an exemplary method of generating a reference image. FIG. 13 illustrates the generation of one structural period unit because the following description will be made on an exemplary comparison which is made on a unit-by-unit basis. The number of periods can be increased to n in the same method.

Assume that a test is conducted in a direction indicated by an arrow A in FIG. 13. Assume also that period 4 is chosen to be a period under inspection. Since the length of the period is entered by the operator while viewing the image, periods 1-6 can be readily recognized in FIG. 13.

The reference period image is generated by adding periods 1-3 immediately before the period under inspection and averaging them in each pixel. Even if a defect is found in any of periods 1-3, the influence is not significant because these periods are averaged. The reference period image thus generated is compared with the period image 4 under inspection to extract defects.

When a period image 5 under inspection is next tested, periods 2-4 are averaged to generate a reference period image. Subsequently, a period image under inspection is generated from images captured before the capturing of the period image under inspection in a similar manner to continue the test.

Die Test (Random Test)

The die test is applied without limited by the structure of die. The test involves comparing a reference image with an image under inspection, and extracting differences therebetween as defects. The reference image and image under inspection may be digitized images or multi-valued images for improving the detection accuracy. While defects may be differences themselves between the reference image and the image under inspection, a secondary determination may be made in order to prevent erroneous detections based on difference information such as the amount of detected difference, a total area of pixels which present differences, and the like. The die test can be classified according to how a reference image is generated. The following description will be made on the operation of an adjacent die comparison method, a reference die comparison inspection method, and a CAD data comparison method which are included in the die test.

Adjacent Die Comparison Method (Die-Die Test)

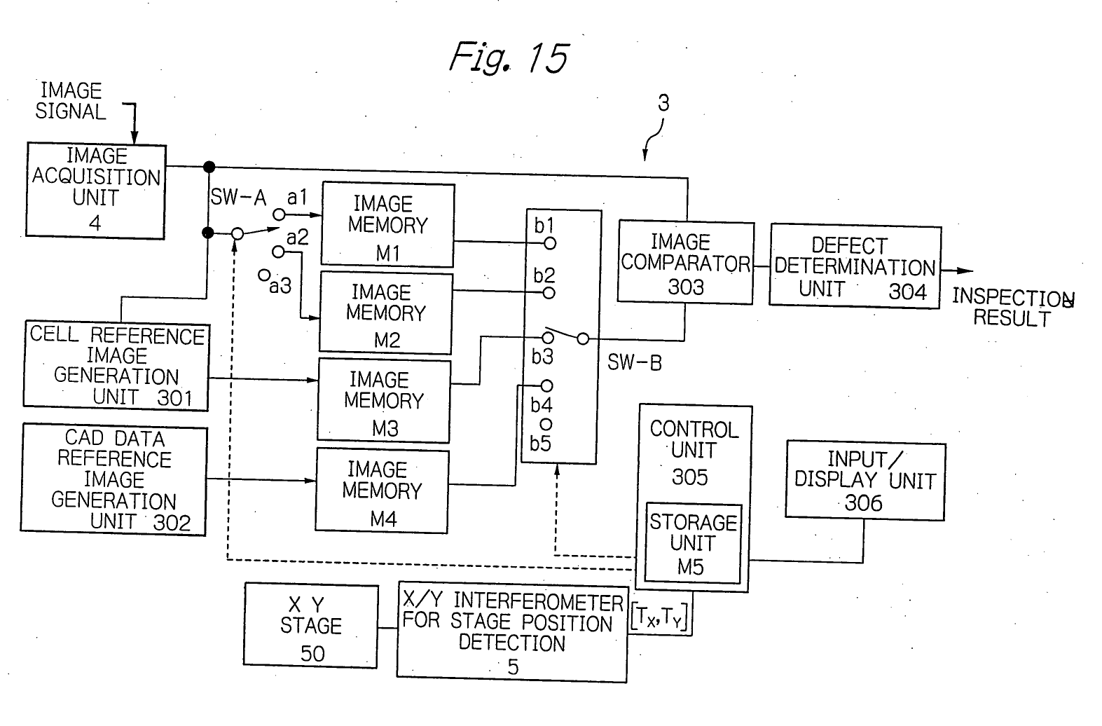

The reference image represents a die adjacent to an image under inspection. Two dies adjacent to the image under inspection are compared to determine a defect. Specifically, referring to FIG. 14, when a wafer is scanned in a direction S, a die image 2 is compared with a die image 1 to obtain a difference therebetween and a die image 3 is compared with the die image 2 to obtain a difference therebetween. Then on the basis of the obtained differences, it is determined whether or not there is a defect.

Settings may be made to correct the two images to be compared such that a position alignment, i.e., a difference in position is eliminated in the two image before the difference obtaining procedure. Alternatively, a correction may be made to eliminate density alignment, i.e., a difference density. In some cases, both processes may be required.

Reference Die Comparison Method (Die-Any Die Test)

The operator specifies a reference die. The reference die is a die existing on a wafer, or a die image saved before the test. First, the reference die is scanned or transferred to store its image in a memory for use as a reference image. Then, an inspection image obtained by scanning is compared with the reference image of a reference die to obtain a difference therebetween. On the basis of the difference, it is determined whether or not a defect exists.

Before the difference obtaining procedure, at lease one of settings may be made to correct the two images to be compared such that a position alignment, i.e., a difference in position is eliminated in the two image, and correct so as to eliminate density alignment, i.e., a difference density. The reference image may be the entire image of the reference die or a part of the entire image which is updated.

CAD Data Comparison Method (CAD Data-Any Die Test)

A certain image is created for use as a reference image from CAD data which is the output of a CAD-based semiconductor pattern designing process. The reference image may represent an entire die, or part thereof which includes a portion under inspection. This CAD data is typically vector data which cannot be used as the reference image unless the CAD data is converted to raster data equivalent to image data captured by a scanning operation. Thus, the following conversion process is executed in regard to the CAD data processing operation.

a) Vector data, which comprises the CAD data, is converted to raster data.

b) The foregoing step a) is performed in units of image scanning width which is known by scanning the die under inspection during a test.

c) The foregoing step b) converts image data which is at the same relative position in the die as an image which is expected to be captured by scanning the die under inspection.

d) The foregoing Step c) is performed while the test scanning is overlapped with the conversion operation.

While the foregoing Steps a)-d) are an exemplary sequence of making a conversion in units of image scanning widths for faster processing, the test can be conducted without fixing the conversion unit to the image scanning width. As an additional function to the operation for converting vector data to raster data, at least one of the following functions is provided.

a) A function of converting raster data to multi-value data.

b) A function of setting a gradation weight and an offset for the conversion to multi-value data in view of the sensitivity of the inspection apparatus in regard to the foregoing function a).

c) A function of processing an image for modifications such as expansion, reduction and the like after vector data has been converted to raster data.

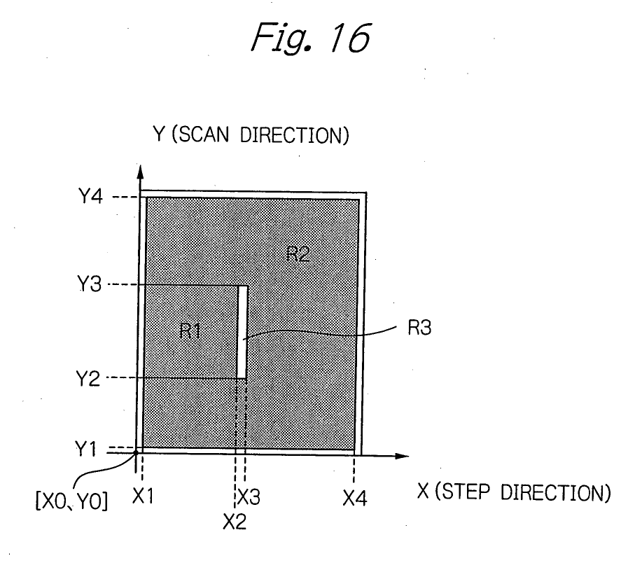

FIG. 15 is a block diagram illustrating the main configuration of a defect inspection apparatus according to the present invention, which can be applied to the inspection system 1 described above. The defect inspection apparatus is configured to selectively execute any of the aforementioned test or inspection algorithms (cell inspection method, adjacent die comparison method, reference die comparison method, and CAD data comparison method) on the basis of a previously set sequence.

In FIG. 15, the numeral 4 denotes an image+acquisition unit 4 which processes and quantizes an output from the opto-electro system 70, such as an output from a camera consisting of CCDs or TDIs of an image projection type opto-electro system to generate digital data having multi values. The image projection opto-electro apparatus is configured to detect secondary electrons, reflected electrons, backward scattered electrons or the like as light signals, through a secondary opto-electro system, an MCP, a fluorescent plate and a relay lens, and then convert the light signals to electric signals. Instead of the image projection type opto-electro apparatus, SEM apparatus can be employed as the opto-electro system 70.

Further, in FIG. 15, the numeral 5 denotes an X/Y interferometer 5 for detecting a position of an XY-stage 50 to provide a scanning position coordinate [Tx, Ty] indicative of a current scanning position of a wafer or sample to a defect inspection apparatus 3.

The defect inspection apparatus 3 comprises a Cell reference image generation unit 301, a CAD Data reference image generation unit 302, an image comparator 303, defect determination unit 304, a control unit 305, an input/display unit 306, image memories M1-M4 and switches (switching circuits) SW-A and SW-B.

The control unit 305 outputs control signals to the switches SW-A and SW-B, in response to signals which were previously provided from the input/display unit 306 thereto and which are associated with operator manipulation inputs to the unit 306, and the scanning position coordinate [Tx, Ty] on the wafer on the XY-stage 50 which is currently provided from the X/Y interferometer 5. The control unit 305 comprises a storage unit M5 for storing “switching conditionals” of the switches SW-A and SW-B associated with relationships between inspection areas on the wafer and inspection algorithms to be adopted, namely which area should be inspected with which inspection algorithm.

The relationships between the inspection algorithms and switching conditions of the switches SW-A and SW-B are as follows:
Cell inspection algorithm

SW-A: connect to a contact a3 (Since none of the image memories M1 and M2 is used, it is possible to connect a contact a1 or a2.)

SW-B: connect to a contact b3
Adjacent die comparison inspection algorithm

SW-A: alternately connect the contact a1 for an odd-numbered (or an even-numbered) die and the contact a2 for the even-numbered (or the odd-numbered) die

SW-B: alternately connect a contact b2 for the odd-numbered (or the even-numbered) die (when connecting to the contact a1 of SW-A) and a contact b1 for the even-numbered (or odd-numbered) die (when connecting to the contact a2 of the SW-A)
Reference die comparison inspection algorithm

SW-A: connect to the contact a1 or a2 only when storing an image of a reference die

SW-B: connect to the contact b1 or b2
CAD data comparison inspection algorithm

SW-A: connect to a contact a3 (Since none of the image memories M1 and M2 is used, it is possible to connect a contact a1 or a2.)

SW-B: connect to a contact b4

In the cell inspection algorithm, a reference image is periodically created by taking a weighted average of images of cells preceding to a cell currently under inspection, and thus is updated as a current inspection area is changed. Therefore, the reference image data in the image memory M3 is also updated and comparison is executed using the updated reference image in the memory M3 and an image obtained from the current inspection area.

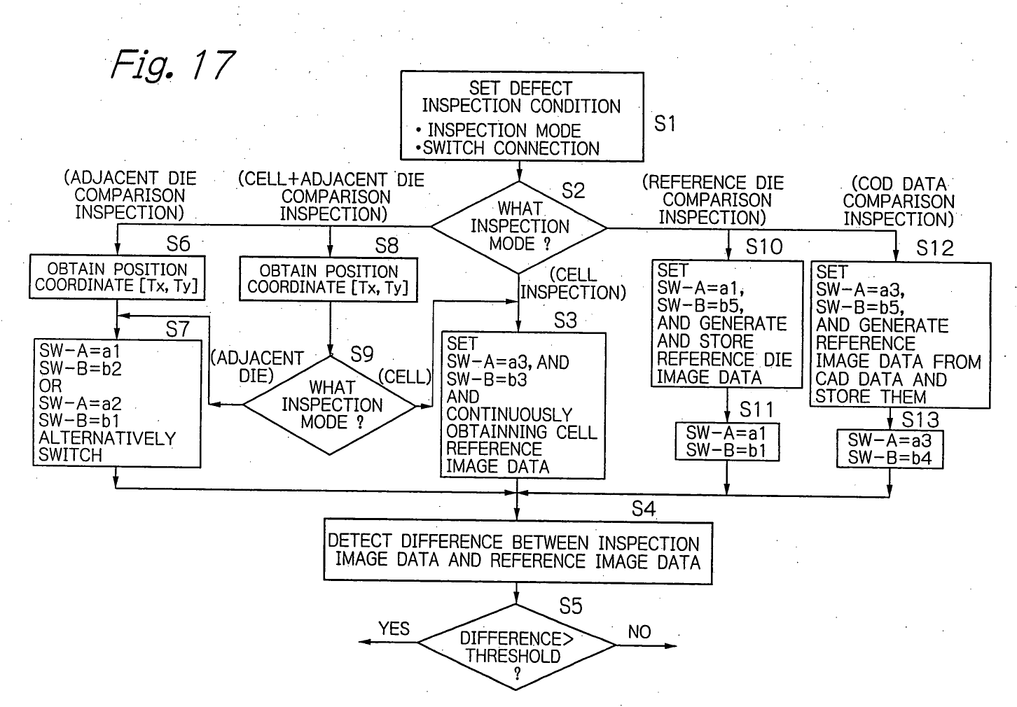

Referring to FIG. 16, the switching conditionals stored in the storage unit M5 will be explained.

FIG. 16 is a schematic diagram illustrating a die on a wafer with a position coordinate, in which X-axis is a step movement direction and Y-axis is a scanning direction. A symbol R1 denotes an area (including boundary lines) where the cell inspection algorithm is executed, R2 an area (excluding boundary lines) where the adjacent die comparison inspection algorithm is executed, and R3 a none-inspection area. To simplify the explanation, it is assumed that a TDI sensor having a visual field of 2048 pixels in the X direction is utilized, and one step movement in the X direction makes no overlap portion and corresponds to 2048 pixels. It is also assumed that the number of the pixels of the non-inspection area R3 in the X direction (X2 to X3) is 2048.

When a wafer including such dies each consisting of the areas R1-R3 as above is bidirectionally scanned (namely, alternately scanning in +Y direction and −Y direction through a step movement in the +X direction, the following switching conditionals are made and stored in the storage unit M5:
if((X1<=Tx)&(Tx<=X2−X[2048]))&((Y2<=Ty)&(Ty<=Y3))
   then switch SW-B connects to contact b3
else if((X1<=Tx)&(Tx<=X4−X[2048]))&((Y1<=Ty)&(Ty<=Y4))
   if current die is odd numbered
      then switch SW-A connects to contact a1 & switch SW-B connects to contact b2
   if current die is even numbered
      then switch SW-A connects to contact a2 & switch SW-B connects to contact b1

In the above, X[2048] is a step length or a length of 2048 pixels in X direction.

Although the example explained above with reference to FIG. 16 is relatively simple, the inspection apparatus according to the present invention is capable of selectively executing the above four inspection algorithms by setting the switching conditionals of the switches SW-A and SW-B. Instead of the switching conditionals, a look-up table defining switching connections may be employed.

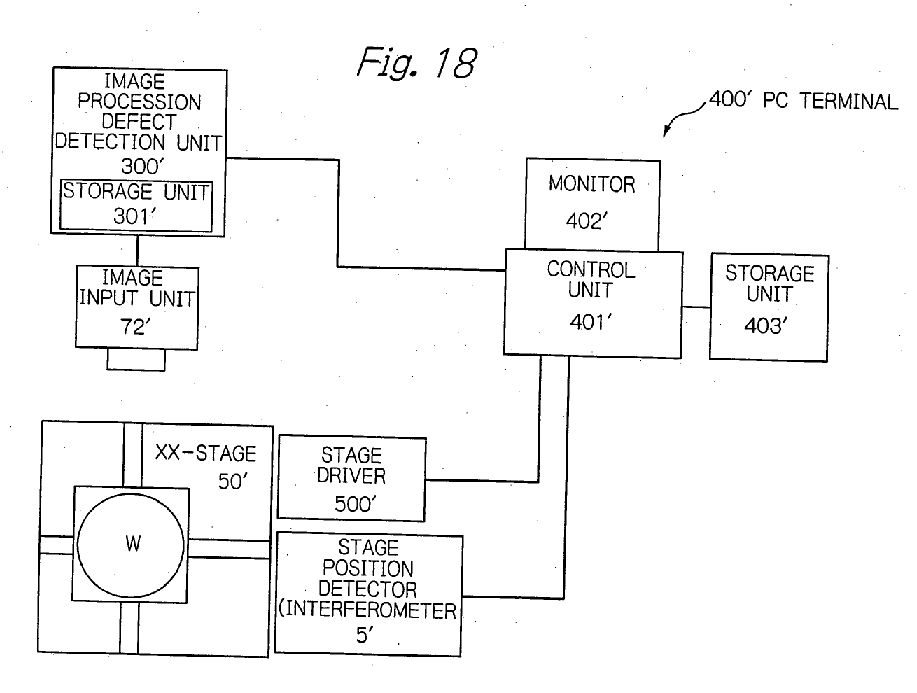

An operation of the defect inspection apparatus shown in FIG. 15 will be explained in detail with reference to a flowchart illustrated in FIG. 17.

In Step S1, before starting an actual inspection procedure, inspection conditions are set by manipulating the input/display unit 306 by an operator. The inspection conditions include types of inspection algorithms associated with inspection areas and connection positions of the switches SW-A and SW-B for the respective inspection algorithms, and are stored in the storage unit M5 of the control unit 305. In this example, the following types of inspection algorithms are set.
Cell inspection
Adjacent die comparison inspection
Cell inspection+Adjacent die comparison inspection
Reference die comparison inspection
CAD data comparison inspection

Another type of inspection algorithm such as cell inspection+Reference die comparison inspection may be included.

The connection positions of the switches SW-A and SW-B are set correspondingly to a coordinate [Tx, Ty] of inspection position, which will be provided from the X/Y interferometer 5.

The cell inspection+adjacent die comparison inspection algorithm is a combination of the cell inspection algorithm and the adjacent die comparison inspection algorithm.

When an actual inspection of the wafer is started, the control unit 305 judges at Step S2 what inspection mode should be executed.

If it is the “cell inspection”, the control unit 305 controls the switches SW-A and SW-B to connect to the contacts a3 and b3, respectively at Step S3. Then the cell reference image generation unit 301 generates a cell reference image using image data of a cell on a wafer which is outputted from the image acquisition unit 4, and stores the generated cell reference image. This operation is continuously performed, and thus the cell reference image stored in the memory M3 is updated in response to the inputted cell image data. Alternatively, it is possible that a cell reference image data is previously generated and stored, and the stored data is used during the cell inspection mode.

The image data stored in the image memories M1-M4 corresponds to one sworth (=X[2048]*(die length in Y direction). As to the image data stored in the image memory M3, the data of one cell cycle is used for comparison.

Next, at Step 4, the image comparator 303 compares real time image data obtained at the image acquisition unit 4 with the reference image data from the image memory M3 to derive a difference therebetween pixel by pixel. The defect determination unit 304 judges at Step S5 whether the difference for one pixel is larger than a predetermined threshold value, and if so, it determines that a defect exists at a location corresponding to the pixel. The results of the determination are stored in a storage unit (for instance, the storage unit M5), and displayed at the input/display unit 306 if necessary.

If it is determined at Step S2 that the inspection mode is “adjacent die comparison inspection”, the control unit 305 obtains a coordinate [Tx, Ty] indicative of a position currently under inspection from the X/Y interferometer 5 at Step S6, and controls the switches SW-A and SW-B to connect to the contacts a1 and b2 or a2 and b1, by retrieving the switching conditionals associated with the obtained position coordinate form the storage unit M5 at Step S7. Namely, when a die currently under inspection is (2n+1)-th (odd numbered), the switches SW-A and SW-B are connected to the contact a1 and b2, and thereby real time image data from the image acquisition unit 4 and image data of the 2n-th (even numbered) die which is a reference image data, are inputted to the image comparator 303. On the other hand, when a die currently under inspection is 2n-th (even numbered), the switches SW-A and SW-B are connected to the contact a2 and b1, and thereby real time image data from the image acquisition unit 4 and image data of the (2n−1)-th (odd numbered) die which is a reference image data, are inputted to the image comparator 303.

Then at Steps S4 and S5, in a manner similar to the forgoing, it is determined by the operations of the image comparator 303 and defect determination unit 304 whether the die currently under inspection contains a defect.

If it is determined at Step S2 that the inspection mode is “reference die comparison inspection”, the process goes to Step S10, where the control unit 305 controls the switches SW-A and SW-B to connect to the contacts a1 and b5, respectively to store in the image memory M1, image data of a reference die which has been previously selected. Next, at Step S11, the control unit 305 controls the switches SW-A and SW-B to connect the contacts a3 and b1, respectively. Then, at Steps S4 and S5, it is determined by the operations of the image comparator 303 and defect determination unit 304 whether the die currently under inspection contains a defect.

If it is determined at Step S2 that the inspection mode is “CAD data comparison inspection”, the control unit 305 controls the switches SW-A and SW-B to connect to the contacts a3 and b5, respectively, and controls the CAD data reference image generation unit 302 to generate a sworth unit of reference image data. The generated data is stored in the image memory M4. Next, at Step S13, the control unit 305 controls the switches SW-A and SW-B to connect the contacts a3 and b4, respectively. Then, at Steps S4 and S5, it is determined by the operations of the image comparator 303 and defect determination unit 304 whether the die currently under inspection contains a defect.

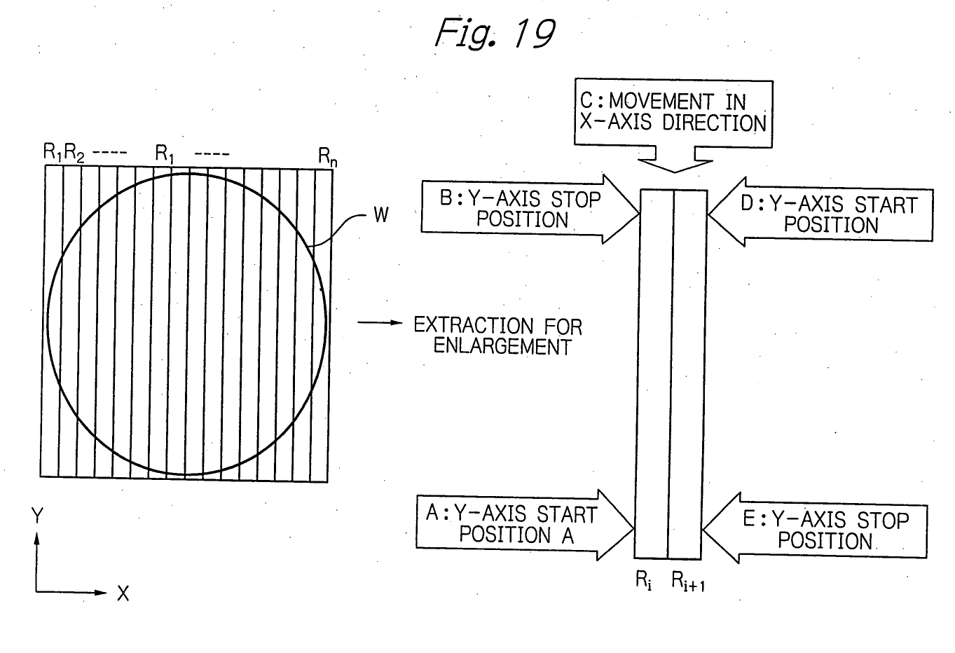

FIG. 18 shows a block diagram illustrating a defect inspection apparatus according to a second aspect of the present invention, which is applicable to the inspection system 1 as stated above. This defect inspection apparatus is also constituted to selectively execute any of the aforementioned inspection algorithms (cell inspection method, adjacent die comparison method, reference die comparison method, and CAD data comparison method), on the basis of a predetermined inspection sequence.

In FIG. 18, the symbol 5′ denotes an X/Y interferometer or stage position detector, 50′ an XY-stage which forms a part of an electron beam device; and 500′ a stage driver. The stage driver 500′ includes servo motors 521, 531 and encoders 522, 532, as shown in FIGS. 1 and 2. Further, the symbol 72′ denotes an image input unit 72′ which forms a part of the opto-electro system 70, 300′ an image processing/defect detecting unit, and 400′ a computer terminal such as a PC terminal or the like for an operator.

The defect inspection apparatus according to the present invention can employ an arbitrary electron beam device such as a SEM type, image projection type, and the like. When the defect inspection apparatus employs an electron beam device of an image projection type, the image input unit 72′ is a line sensor comprised, for example, of a CCD camera. A semiconductor wafer W is placed on the XY-stage 50′.

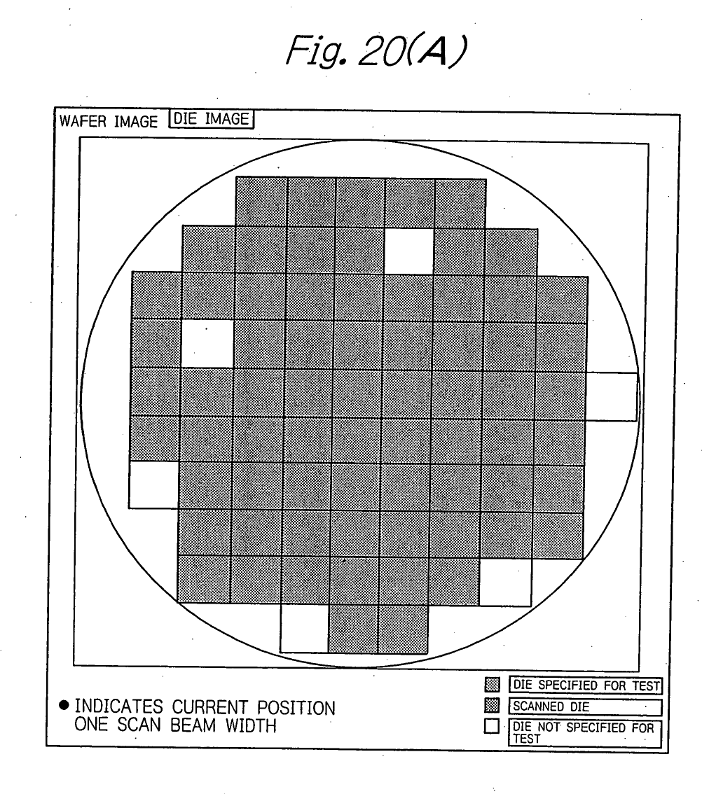

FIG. 19 is a schematic diagram for describing how a wafer is scanned by moving the stage 50′. Each of rectangles R₀, R₁, R₂, . . . , Rₙ in FIG. 19 has a width in an X-axis direction equal to one sworth (for example, 2,048 dots) which is the width of the line sensor.

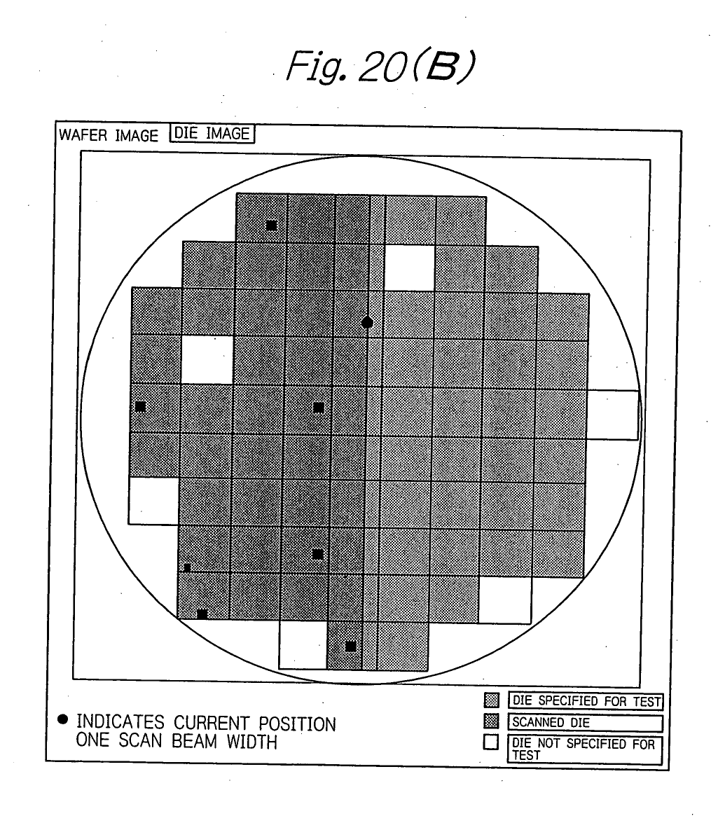

FIGS. 20A-20C are schematic diagrams each illustrating a screen displayed on a monitor 402′ of the PC terminal 400′, in which FIG. 20A illustrates the screen at the start of an inspection, FIG. 20B the screen in the middle of the inspection, and FIG. 20C the screen at the end of the inspection. In FIGS. 20A-20C, each of a plurality of squares (which may be replaced by rectangles) represents a die on a wafer, and each hollow square represents a die not specified for the inspection.

Now, an operation of the second defect inspection apparatus in the present invention will be described with reference to FIGS. 18, 19, and 20A-20C.

First, an operator initially sets condition information required for a current inspection on the monitor 402′ of the PC terminal 400′, including an inspection recipe or prescription (including an inspection algorithm(s)), inspection conditions, specified dies to be inspected, a specified area to be inspected, a specified scanning direction(s) (bi-directions, forward direction, or reverse direction), a specified stage speed, and the like. The following description will be made on the assumption that scanning is specified to execute in a bi-direction mode.

After the initial settings as above have been made, a control unit 401′ of the PC terminal 400′ displays an image of a wafer on the monitor 402′, as illustrated in FIG. 20A. Then, at the start of a defect test, the control unit 401′ controls the stage driver 500′ to set an initial position of the stage 50′ such that an image of a start position A of the rectangle R₀ can be captured by the image input unit 72′.

Next, the control unit 401′ controls the stage driver 500′ to capture an image of the rectangle R₀ while moving the stage 50′ in the −Y direction. When the scanned position on the wafer W reaches a stop position B, one scanning operation is completed, causing the control unit 401′ to stop the movement of the stage 50′ in the Y direction. During the scanning of the rectangle R₀, captured image data is sequentially sent to the image processing/defect detecting unit 300′ for executing defect detection processing, and the result of the processing is stored in a defect inspection result storage unit 301′. The storage unit 301′ has a capacity large enough to store the defect inspection result data for at least one rectangle, i.e., the data captured during one scanning operation.

As the scanning on the wafer W reaches the stop position B, the controller 401′ controls the stage driver 500′ to move the stage 50′ in the −X-axis direction by a width of one sworth (for example, a width corresponding to 2,048 dots). In parallel with the movement, the control unit 401′ instructs the image processing/defect testing unit 300′ to read the defect inspection result data for the rectangle R₀ from the defect inspection result storage unit 301′ for transfer to the control unit 401′ of the PC terminal 400′. The control unit 401′ stores the defect inspection result data transferred thereto in a storage unit 403′. This storage unit 403′ has a capacity large enough to store defect inspection result data for all the rectangles R₁ to Rₙ.

Alternatively, instead of providing the storage unit 301′ in the image processing/defect detecting unit 300′, the defect inspection result data may be directly transferred to the PC terminal 400 for storage in the storage unit 403′.

Then, the control unit 401′ reads the defect inspection result data for the rectangle R₀ from the storage unit 403′, and displays the read data on the monitor 402′ with a different color or the like so that the operator can easily distinguish the rectangle R₀ from untested rectangles. Specifically, on the monitor 402′, the rectangle R₀ is displayed in a width of one sworth at a position in accordance with coordinate data on the X-axis from the stage position detector 5′.

Also, in this event, when the defect inspection result data includes a defect detection data, the control unit 401′ displays a different color at the associated location. A defect may be displayed using a different shape or using symbols such as ◯ and ×, instead of using a different color. The image processing/defect detecting unit 300′ manages locations of defects by the amount of effective pixels (equal to the number of pixels) from the image input unit (camera) 72′. The control unit 401′ has stored the coordinate of the start position A on the Y-axis, and upon receipt of defect data, changes the color at a position on the monitor 402 based on the number of effective pixels from the start position A to the location indicated by the defect data. For example, in an observation in which one pixel is enlarged to 100 nm, it is assumed that the control unit 401′ receives defect inspection result data of one sworth (equal to 2,048) multiplied by ten from the start timing, and the data received at this time is defect data. Since this means that a defect is detected at a location away from the start position A in the Y direction by ten pixels, the control unit 401′ changes color at a location 1,000 nm away from the start position A.

In this way, the control unit 401′ does not need to capture the Y-axis coordinate corresponding to the location of the defect from the stage position detector 5′.

As the stage 50′ has moved over the width of one sworth in a step in the X-axis direction, the control unit 401′ controls the stage driver 500′ to move the stage 50′ in the +Y direction, thus sequentially capturing image data of the rectangle R₁ from a start position D to a stop position E. In a manner similar to that of the rectangle R₀, the image processing/defect detecting unit 300′ attempts to detect defects in the captured data. As the stage 50′ reaches the stop position E, defect inspection result data for the rectangle R₁ is transferred to the control unit 401′ and displayed on the monitor 402.

In this way, the rectangles R₀, R₁, R₂, . . . are sequentially inspected while reversing the scanning direction (Y direction), and the results of the inspection are displayed on the monitor 402′ of the PC terminal 400′, as illustrated in FIG. 20B. When the operator, who is monitoring the result of the defect inspection displayed on the screen as illustrated, finds a large number of defect detected locations or that the total area of detected defect locations is large, the operator aborts the wafer defect inspection at this time, and causes the control unit 401′ to store a mark indicative of a defective wafer in the storage unit 403′ in correspondence to this wafer, even if the inspection on the wafer W has not been completed. In this way, it is possible to reduce a time for uselessly inspecting a defective wafer.

When the wafer W is scanned up to the last rectangle Rₙ to detect possible defects, an image is displayed on the monitor 402′ as illustrated in FIG. 20C. Even at this time, the operator can determine whether or not the wafer is defective.

As previously described in connection with FIG. 8, it is preferable that the operator specifies dies under non-inspection (dies excluded from the inspection) on the wafer W before the defect inspection is conducted. As mentioned above, locations corresponding to the dies specified as dies under non-inspection are displayed in a different color or the like on the monitor 402′, for distinction from the others, as illustrated in FIGS. 20A-20C. The dies under non-inspection may include dies which have been previously known to be defective, and generally defective dies around the periphery of a wafer.

Alternatively, the defect inspection apparatus can be set to inspect only a predetermined area within each die, in which case a location corresponding to an area not under test within the die is displayed in a different color.

In the foregoing description, during the step-by-step movement of the stage 50′ in the X direction, i.e., at each time when scanning operation in the Y direction finishes, defect inspection result data for the one complete scanning operation is transferred from the image processing/defect detecting unit 300′ to the PC terminal 400′ for display on the monitor 402′. Alternatively, even during the scanning of one rectangle Rᵢ, each time every sworth (one detection unit) or every plurality of sworths of defect inspection result data are captured, the data may be transferred to the control unit 401′ so that the data is sequentially displayed on the monitor 402′.

In this strategy, the X-axis coordinate and Y-axis coordinate of a position currently being scanned may be captured from the stage position detector 5′ to display the defect inspection result data at that position.

Further alternatively, the wafer W may be scanned only in the forward direction or in the reverse direction, i.e., in one direction as mentioned above by settings made by the operator on the PC terminal 400′, instead of the bidirectional scanning which involves alternately reversing the scanning direction of the wafer W. In any way, the control unit 401′ instructs the stage driver 500′ to drive the stage 50′ in accordance with a set scanning direction(s).

The defect inspection apparatus can be further configured to permit the operator to set the number of defect locations or an upper limit of area dimension of defects (or an alarm value lower than the upper limit value), which is allowable as a non-defective product, on the PC terminal 400. In this event, the set upper limit is stored in the storage unit 403′, and the control unit 401′ accumulates defective locations or the dimensions of areas in defect inspection result data captured by the defect detecting unit 300′, and displays on the monitor 402′ that a defective product (or a defective similar product) is detected at the time when the accumulated value reaches the upper limit, and stops the operation of the stage driver 500′.

Furthermore, when the image input unit 72′ comprises a line sensor of 2,048 dots, adjacent rectangles Rᵢ, Rᵢ₊₁ may be set to overlap by about 16 dots, which is suitable for determining the continuity of line patterns on a wafer.

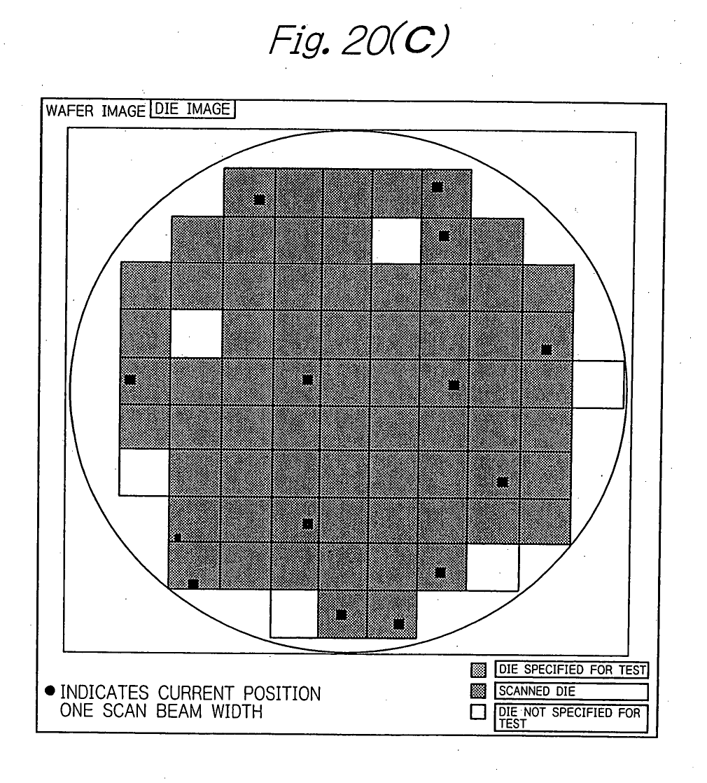

The defect detection processing in the image processing/defect detecting unit 300′ can be carried out using an arbitrary technique which compares captured image data with reference image data to determine a defect when there is a difference therebetween equal to or larger than an allowable error. However, since the image processing/defect detecting unit 300′ is preferably configured to selectively execute a plurality of inspection algorithms, as mentioned above, it preferably has the configuration (defect inspection unit 3) illustrated in FIG. 15 or a configuration illustrated in FIG. 21 which will be explained below.

FIG. 21 illustrates an exampled configuration of the image processing/defect detecting unit 300′, which can selectively execute the cell inspection algorithm and die-to-die inspection algorithm (adjacent die inspection algorithm). The image processing/defect detecting unit 300′ comprises a cell reference image generation unit 302′, an image comparator 303′, a defect determining unit 304′, image memories M1′-M3′, and switches SW-A′ and SW-B′ which are switched by control signals from the control unit 401′ of the PC terminal 400′.

The following description will be made on an operation of the image processing/defect detecting unit 300′ illustrated in FIG. 21.

As an operator makes settings on the PC terminal 400′ to execute the cell inspection algorithm, the control unit 401′ controls the switch SW-B′ of the defect detecting unit 300′ to connect to a contact b3. Since each of the image memories M1′ and M2′ is not used in the cell inspection algorithm, the switch SW-A′ may be connected to any contact.

In the cell inspection algorithm, the cell reference image generator 302′ captures cell reference image data from a plurality of cells which are arranged immediately before a cell currently under inspection, simultaneously with the inspection of the current cell. Since the generation of the data involves taking a weighted average during a predetermined period, the data is updated as appropriate as an area under inspection is changed. The updated cell reference image data is stored in the image memory M3′ to update the stored data.

Then, the image comparator 303′ compares the updated reference image data with currently captured image data (from the image input unit 72′) to find a difference therebetween. The defect determining unit 304′ determines whether or not the difference is larger than a predetermined threshold, and determines that a defect is present at a location currently under inspection when the difference is larger than the threshold. The result of the determination is stored in the storage unit 301′.

When the operator has set the die-to-die inspection algorithm, the control unit 401′ controls the switch SW-A′ to alternately connect to the contacts a1 and a2 in accordance with whether the inspection is conducted for an odd-numbered die or an even-numbered die, and conversely controls the switch SW-B′ to alternately connect to the contacts b2 and b1. A die which is now under inspection can be determined based on the position coordinates from the stage position detector 5′.

Specifically, when a die currently under inspection is a (2n+1)th (odd-numbered) die, the switches SW-A and SW-B are connected to the contacts a1 and b2 (or a2 and b1), respectively, so that the real time image data from the image input unit 72′ and reference image data which is image data of a 2n-th (even-numbered) die stored in the image memory M2 are supplied to the image comparator 303′. On the other hand, when a die currently under inspection is a 2n-th die, the switches SW-A and SW-B are connected to the contacts a2 and b1 (or a1 and b2), respectively, so that the real time image data from the image input unit 72′ and reference image data which is image data of a (2n−1)th die stored in the image memory M1′ are supplied to the image comparator 303′.

Then, by the image comparator 303′ and defect determining unit 304′, it is determined whether a defect is present at a location currently under test, and the result is stored in the defect inspection result storage unit 301′, similarly to the case of the cell inspection algorithm.

In addition to the foregoing algorithms, the image processing/defect detecting unit 300′ may be configured to selectively execute at least one of a reference die comparison inspection algorithm and a CAD data comparison inspection algorithm, where the selection may be controlled by the control unit 401′ of the PC terminal 400′. Also, the cell inspection algorithm and die-to-die inspection algorithm may be switched on a die-by-die basis in accordance with a location within a die.

Also, as described above, the result of the determination made by the defect determination unit 304′ may be directly transferred to the PC terminal 400′ for storage in the defect inspection result storage unit 403′, without providing the defect test result storage unit 301′ in the image processing/defect detecting unit 300′.

As described above, the present invention is capable of executing a defect inspection of a semiconductor wafer or the like at a high throughput, and therefore, manufacturing of the semiconductor wafer can be improved.

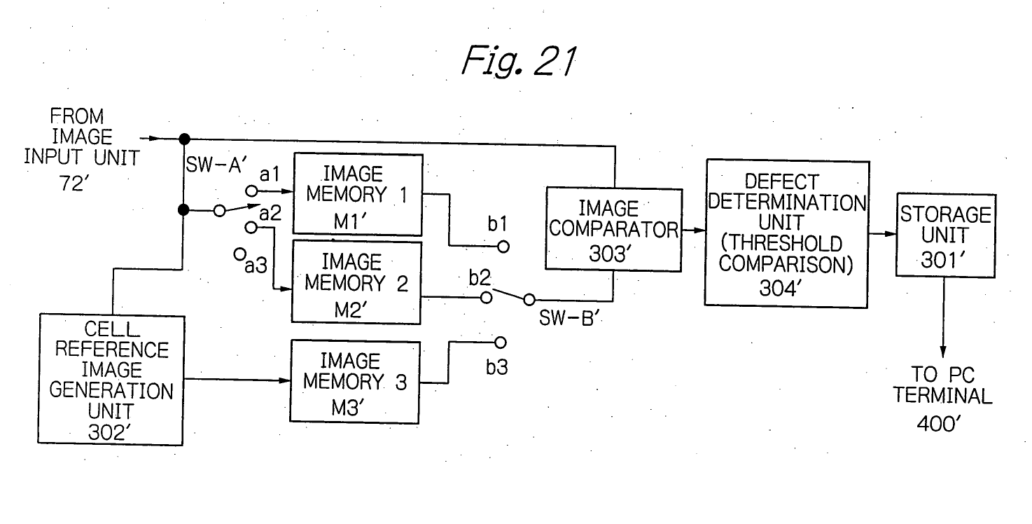

Referring to FIGS. 22-25, a creation operation of a focus map recipe which is one of the recipes and an auto-focus operation executed during an inspection operation using it will be explained.

In the following example, the focus map recipe has an independent input screen, and the operator executes the following steps to create the focus recipe. Such an input screen may be added to an input screen provided for different purposes.

a) A step of entering focus map coordinate representing the position of a die, a pattern within the die, or the like for which a focus value is entered using a switch 126-1 on a monitor screen illustrated in FIG. 22.

b) A step of setting a die pattern which is required for automatically measuring a focus value. This step may be skipped when the focus value is not automatically measured.

c) A step of setting a best focus value at the coordinate on the focus map determined at the foregoing Step a).

Among the foregoing steps, while the operator can specify an arbitrary die at Step a), other setting can also be made, such as a selection of all dies, a selection of every n die, and the like. In addition, the operator can select the input screen from any of a figure which schematically represents the arrangement of dies within a wafer and an image which uses an actual image.

At Step c), the operator manually selects a switch 126-3 in FIG. 22 and sets a focus value using a focus switch 126-2 which is associated with a voltage value provided to a focusing electrode, or select a switch 126-4 in FIG. 52 to automatically find a focus value to be supplied.

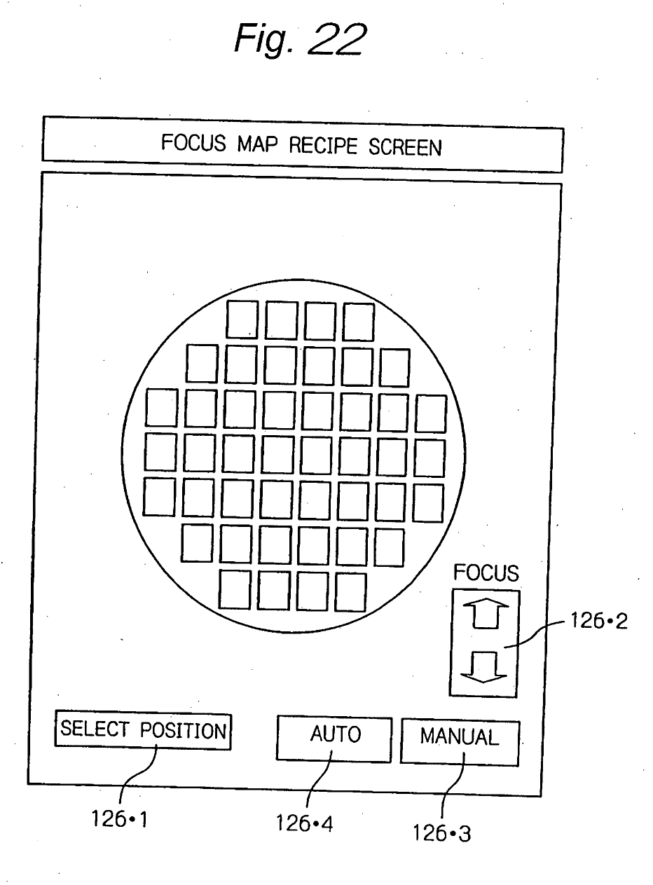

A procedure for automatically finding a focus value at the forgoing Step c) involves, for example, the following steps (see FIG. 23):

a) finding an image with a focus position Z=1, and calculating the contrast thereof;

b) performing the foregoing Step a) while each of focus positions Z=2, 3, and 4;

c) regressing from the contrast values calculated at Steps a) and b) to find a contrast function; and

d) calculating a Z value which results in a maximum value of the contrast function, and choosing it to be the best focus value.

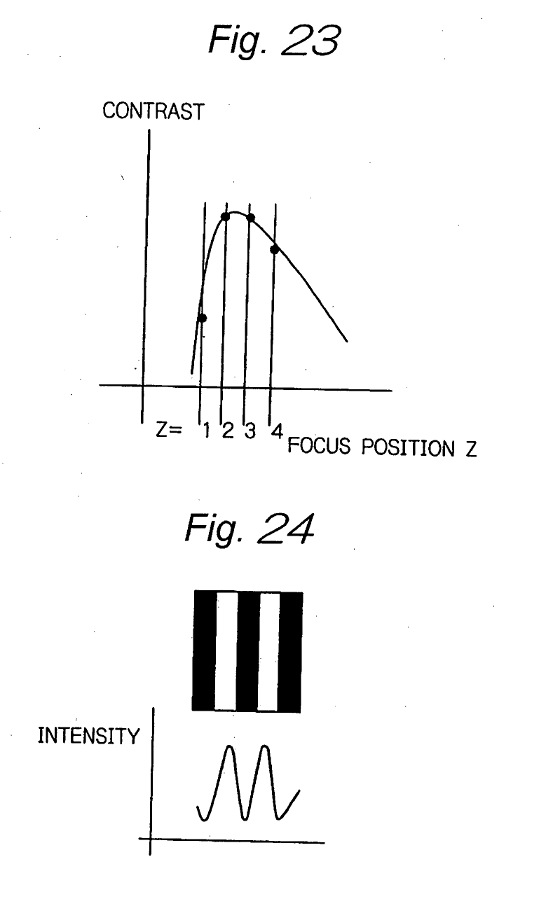

For example, a die pattern required for automatically measuring a focus value presents good results when a selected pattern consists of alternating lines and spaces as illustrated in FIG. 24, the contrast can be measured irrespective of the shape of a black and white pattern, whichever one is selected.

The single best focus value can be found by executing Steps a) to d). A data format in this event is (X, Y, Z), which is a combination of a set of the coordinate values X and Y at which the focus is found, and the best focus value Z. Therefore, there exist a number of focus map coordinates (X, Y, Z) determined by the focus map recipe. This is part of the focus map recipe, and is called a “focus map file.”

A method of setting a focus to the best focus during an inspection operation for capturing an image and a reviewing operation, is implemented by the following steps.

a) Positional information is further sub-divided based on the focus map file 1 created during the creation of the focus map recipe, and the best focus at this time is calculated to create a sub-divided focus map file 2.

b) The calculation at Step a) is performed using an interpolation function.

c) The interpolation function at Step b) may be linear interpolation, spline interpolation or the like, and is specified by the operator upon creation of the focus map recipe.

d) The current stage position, or a position coordinate [Tx, Ty] of the TDI sensor is monitored, and a voltage at the focus electrode is changed to a focus value described in the focus map file 2 suited to the current X-Y position coordinate.

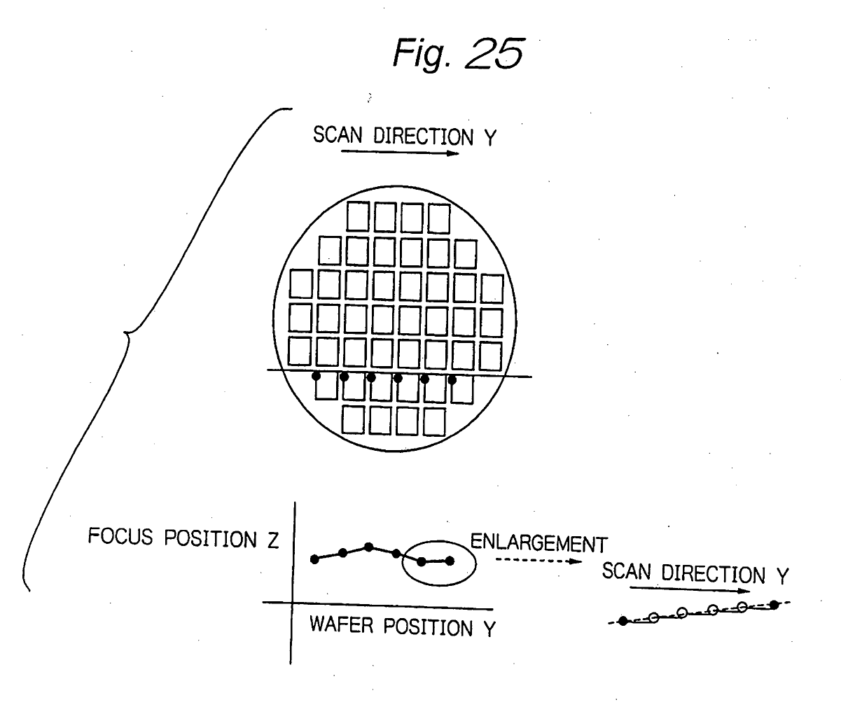

Describing more specifically with reference to FIG. 25, a black circle represents a focus value of the focus map file 1, and a white circle represents a focus value of the focus map file 2. The focus values of the focus map file 2 are inserted between focus values of the focus map file 1. The focused position Z is varied following the scanning to maintain the best focus. In this event, the value of the preceding focus value is maintained between two white circles until the focus position is varied next time.

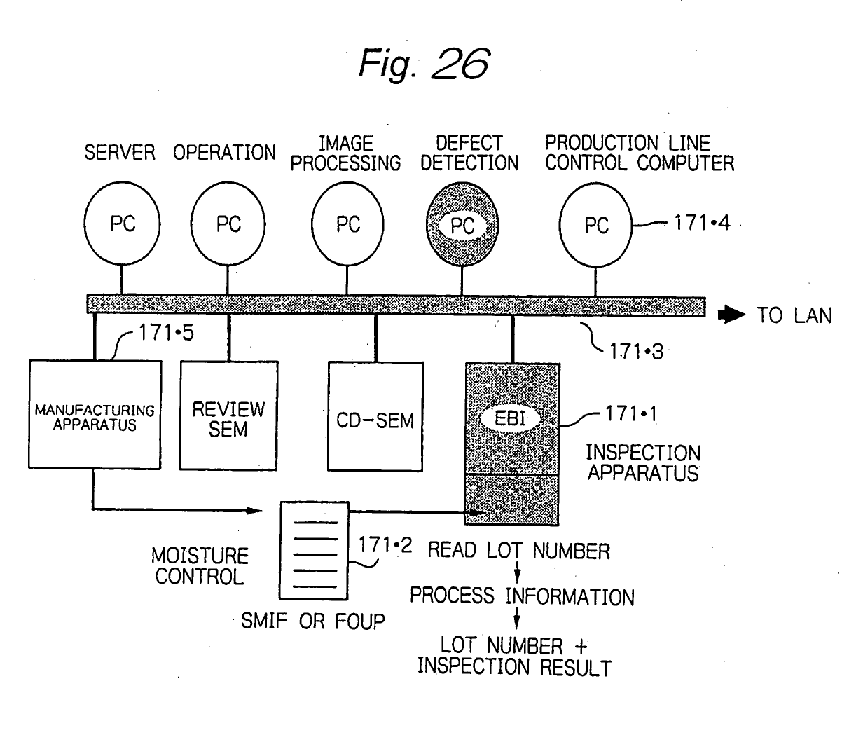

FIG. 26 illustrates an exemplary semiconductor manufacturing plant which employs the defect inspection apparatus according to the present invention. In FIG. 26, the defect inspection apparatus is designated by a reference numeral 171.1. Information such as a lot number of wafers to be tested by the defect inspection apparatus, histories of manufacturing apparatuses, and the like are read from a memory included in SMIF or FOUP 171.2, or the lot number can be recognized by reading an ID number of the SMIF, FOUP 171.2 or a wafer cassette. During the transfer of wafers, the amount of moisture is controlled to prevent oxidization of metal wires and the like.

A PC 171.6 (for instance the controller 305 in FIG. 15) of a defect inspection apparatus 171.1 for controlling a defect detection is connected to an information communication network 171-3 of a production line, so that information such as a lot number of wafers which are objects under inspection, and the result of their tests can be sent to a production line control computer 171-4, a variety of manufacturing apparatuses 171-5, and other inspection systems through the network 171-3. The manufacturing apparatuses 171-5 include those associated with lithography, for example, an exposure apparatus, a coater, a curing apparatus, a developer, and the like, an etching apparatus, deposition apparatuses such as a sputtering apparatus and a CVD apparatus, a CMP apparatus, a variety of measuring apparatuses, other inspection apparatus, and the like.

What is claimed is:

1. An apparatus for inspecting a defect of a sample having patterns thereon, comprising:
means for capturing a pattern image of a pattern on a surface of the sample as a target inspection pattern image;
means for capturing and storing a first reference pattern image;
means for capturing and storing a second reference pattern image;
means for obtaining a current position coordinate of the target inspection pattern image currently captured from the sample surface;
inspection algorithm storage means storing an inspection algorithm which determines in accordance with the current position coordinate whether the target inspection pattern image at the current position coordinate should be compared with the first or second reference pattern image;
means for selecting the first or second reference pattern image as a selected reference pattern image in accordance with the current position coordinate; and
defect determination means for determining whether a defect is present by comparing the target inspection pattern image at the current position coordinate with the selected reference pattern image.
